(19) United States
(12) Patent Application Publication
(10) Pub. No.: US 2024/0281614 A1
(43) Pub. Date: Aug. 22, 2024

(54) OPEN-END TEXT USER INTERFACE

(71) Applicant: Ipsos America, Inc., Troy, MI (US)

(72) Inventors: Kevin GRAY, London (GB); Julia HEDRICK, Troy, MI (US); Aaron TOPINKA, Troy, MI (US); Brandy STANSELL, Troy, MI (US); Alexandre de SAINT-LEON, Paris (FR)

(21) Appl. No.: 18/568,190

(22) PCT Filed: Jun. 10, 2022
(86) PCT No.: PCT/US2022/033129

§ 371 Date: Dec. 7, 2023

Related U.S. Application Data
(60) Provisional application No. 63/209,228, filed on Jun. 10, 2021.

(51) Int. Cl. G06F 40/35; G06Q 30/0203; H04L 67/50

(52) U.S. Cl. CPC G06F 40/35; G06Q 30/0203; H04L 67/535

(57) ABSTRACT

Various aspects of the subject technology relate to systems, methods, and machine-readable media for providing open-ended input data and prompting a response to solicit additional information from a user. A method comprises receiving initial input data. The method includes determining a plurality of categories associated with the initial input data; determining for each category in the plurality of categories, a threshold value and a category likeliness score value; and determining a category match between a category and the input data, where the category is one of a plurality of categories, by calculating when the likeliness score value exceeds the threshold value. The method further includes providing a probe request associated with each category match and determining a prediction score associated with each probe request.

### CROSS-REFERENCE TO RELATED APPLICATIONS

This application claims the benefit of, and priority to, U.S. Provisional Application No. 63/209,228, titled “Autoprobe,” filed on Jun. 10, 2021, the disclosures of which are incorporated by reference herein in their entirety.

### TECHNICAL FIELD

The present disclosure generally relates to facilitating providing open-ended response to a user interface (UI), and more particularly to facilitating providing open-ended responses to a user interface and soliciting additional open-ended responses, by encouraging respondents to provide richer and more relevant responses.

### BACKGROUND

Prompted feedback is usually asked (electronically) via a question and response survey format, configured with multiple choice or input box(es) for answers. The survey remains the same, regardless of the feedback provided by the respondent. Unprompted feedback is usually asked (electronically) via a simple question and a multi-line input box. The respondent is asked to type their response to the question. An expectation of such surveys is that the respondent's top-of-mind response is first. Respondents are given the opportunity to express themselves, including what matters to them, rather than just responding to specific questions asked by the researcher. For example, a Net Promoter Score (NPS) can comprise a 10-point rating scale that inquires how likely the respondent is to recommend a business. The survey can also include an unprompted open-ended question that also inquires why the numerical score was provided. As an example, a restaurant may ask as a two-question survey:

| | |
|---|---|
| Question: | How likely are you to recommend our restaurant to your |
| | friends? |
| Response: | 9 |
| Question: | What is it about our restaurant that prompted you to give |
| | the above score? |
| Response: | The staff were great. |

While unprompted questions provide the opportunity for a respondent to express themselves, the effectiveness of such unprompted questions is often limited by the respondent's lack of understanding as to what they are supposed to write and how detailed they should be. Most responses are therefore short, providing a simple single statement with little detail. When the responses are longer, the responses often don't increase in value as they either answer the wrong question, stray from the question asked, ramble in providing unnecessary information, or provide little detail across several points. Respondents may skip questions they don't understand or want to answer. The survey may be completed with no greater understanding by the recipient, and a sense of time wasted by the respondent.

Most evaluations of response occur post-collection, after the respondent is already no longer present or available to resolve or confirm any unanswered questions or unclear answers.

As a method to provide open-end response, chatbots are a common implementation where there is an exchange between two parties (interviewee and interviewer). However, chatbots employ a regimented protocol when interacting with a respondent. In particular, the respondent can only respond in a directly linear progression of questions. The execution of the exchange with a chatbot is linear in that the chat starts with the chatbot asking a question to which the respondent must provide a response. The chatbot then evaluates that response and either asks a follow-up question or asks a different question. In each case, the respondent must provide a response to progress the exchange and series of questions. If no response is received, the chat will likely terminate or the chatbot will be dormant. Chatbot questions also progress linearly and downwards over time with the respondent providing a new response to each question asked. Due to the linear progression, the respondent cannot go back and change an answer. The chatbot likely only evaluates the new response.

### SUMMARY

Thus, there is a need to mitigate against these issues, to encourage the respondent to write more if they wish, and provide their true thoughts, while ensuring that the content of their response is valuable. It would be more desirable to resolve non-relevant or insufficiently rich answers while the respondent is still present.

The subject disclosure provides for systems and methods for providing an open-ended response in an interactive interface. In particular, the platform encourages the user to adjust their response. The respondent can add more information. Each time the system evaluates the response, the system can evaluate the entirety of the response, including the changes between successive entries. The ability to add additional information and reevaluate the input data surpasses the limitations of prior art or other applications, such as a chatbot.

According to one embodiment of the present disclosure, a computer-implemented method is provided for open-ended data input and prompting a response to solicit additional information. A method comprises receiving initial input data. The method includes determining a plurality of categories associated with the initial input data; determining for each category in the plurality of categories, a threshold value and a category confidence score value; and determining a category match between a category and the input data, wherein the category is from the plurality of categories, by calculating when the confidence score value exceeds the threshold value. The method further includes providing a probe request associated with each category match and determining a prediction score associated with each probe request.

According to one embodiment of the present disclosure, a system is provided including a processor and a memory comprising instructions stored thereon, which when executed by the processor causes the processor to perform a method for providing open-ended input data and prompting a response to solicit additional information. The method includes determining a plurality of categories associated with the initial input data; determining for each category in the plurality of categories, a threshold value and a category confidence score value; and determining a category match between a category and the input data, wherein the category is from the plurality of categories, by calculating when the confidence score value exceeds the threshold value. The method further includes providing a probe request associated with each category match and determining a prediction score associated with each probe request.

According to one embodiment of the present disclosure, a non-transitory computer-readable storage medium is provided including instructions (e.g., stored sequences and/or clusters of instructions) that, when executed by a processor, cause the processor to perform a method for providing open-ended input data and prompting a response to solicit additional information. The method includes determining a plurality of categories associated with the initial input data; determining for each category in the plurality of categories, a threshold value and a category confidence score value; and determining a category match between a category and the input data, wherein the category is from the plurality of categories, by calculating when the confidence score value exceeds the threshold value. The method further includes providing a probe request associated with each category match and determining a prediction score associated with each probe request.

### BRIEF DESCRIPTION OF THE DRAWINGS

FIG. 1 depicts a computing environment for data flow between an exemplary front-and back-end.

FIG. 2 depicts a screenshot of the platform operating in the front-end to assess a category.

FIG. 3 depicts a screenshot of the platform operating in an alternate embodiment of a user interface to assess a category.

FIG. 4 depicts a screenshot of the platform operating in an alternate embodiment of a user interface to assess a category.

FIG. 5 depicts a screenshot of the platform operating in an alternate embodiment of a user interface to assess a category.

FIGS. 6A-6E depict screenshots of the user interface of a platform operating in the front-end.

FIGS. 7A-6D depict screenshots of an alternate embodiment of the user interface of a platform operating in the front-end.

FIGS. 8A-8E depict screenshots of an alternate embodiment of a user interface of a platform operating in the front-end.

FIGS. 9A-9E depict screenshots of an alternate embodiment of a user interface of a platform operating in the front-end.

FIGS. 10A-10F depict screenshots of an alternate embodiment of a user interface of a platform operating in the front-end.

FIGS. 11A-11G depict screenshots of an alternate embodiment of a user interface of a platform operating in the front-end.

FIG. 12 is a block diagram illustrating an example computing environment.

FIG. 13 is an example flow diagram for receiving input information and creating prompts for additional information, according to certain aspects of the present disclosure.

FIG. 14 is a block diagram illustrating an example computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

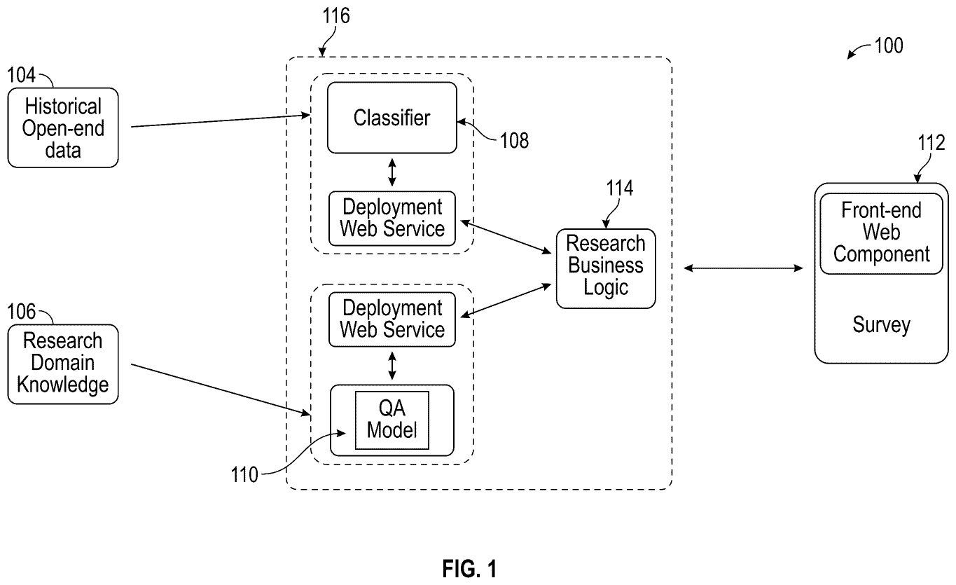

To manage the open-ended data inputs from a survey, a data flow architecture can be defined. An exemplary embodiment of the data flow and processing of the open-ended data is depicted in FIG. 1. The analysis of the input data/(verbatim) in System 100 can implement two artificial intelligence trainers of providing data for two data models. First, the Historical Open-end Data module 104 can be defined and developed from collecting previous open-ended responses. The previous open-ended responses in the Historical Open-end Data module 104 have been parsed and categorized to establish a basis for subsequent open-ended input. The method of categorization may differ depending on the application, the industry, user settings, etc. For example, in the automotive industry, the Historical Open-End Data module can categorize data related categories related to dislikes about a car. In a further example, the categories could include previous open-ended discussions about the dislikes of a car, and about where a problem/issue with a car is located. In another aspect, there can be categorizations comprising aspects that a customer may like about the car. These historical “Dislike” and “Like” categories can establish a basis of prompting a response from a participant when the participant encounters a prompt that solicits additional information. If the goal of an application is to identify issues, then categorizations could be, for example, relating to what are the issues and where are the issues. If, however, the goal of an application is to identify positive traits, then categorizations could be, for example, positive attributes and additional enhancing features. The categorizations can be adapted and adjusted as needed and desired.

Similar to the Historical Open-end Data module 104, the Research Domain Knowledge module 106 provides a more granular basis to aid in training other modules in the data structure. The Research Domain Knowledge module 106 categorizes the key probe (follow-up) questions that may be associated with a categorization. For each of the pre-defined classifications identified from previous open-end responses, the Research Domain Knowledge module contains the key “probe” questions allocated against each category. They are ranked in terms of importance, where importance is based on the value of the likely response. For example, if the categorization of an issue is related to tires, probe questions can include, e.g., How smooth is the ride? Do the tires go flat? and Do the tires require maintenance? In one aspect, the Research Domain Knowledge module 106 comprises at least three probe questions associated with a category. This information is inputted into the QA Model 110 whose purpose is to understand whether a verbatim already satisfies a probe, once the verbatim is known to include content relating to the classification to which the probe relates. The verbatim can be the open-ended response from the participant of a survey. A probe is satisfied if the probe is answered. For example, if the probe is describing the length of a trip you undertake, and the respondent inputs “on short urban trips” then the probe may be considered satisfied (answered). If the probe is not satisfied the probe remains visible until it is satisfied. However, the satisfaction of probes is optional since it is up to the respondent whether they want to adjust their verbatim to include the detail indicated by the probe. Additional questions are not asked if the probe is not satisfied.

The Historical Open-end Data module 104 and the Research Domain Knowledge module 106 can both provide training data to individual models. In one aspect, the Historical Open-end Data module 104 can provide data to help train the Classifier module 108. As depicted in one exemplary path, the Classifier module 108 can receive verbatims as the open-ended input, and classifies the input according to the provided classifications. Through the Classifier 108, the verbatim can be a simple single statement with one classification or a more complex multi-statement with more than one classification. Each classification has a threshold and a likeliness score. The threshold value and the classification likeliness score are numerical values between 0 and 1. Here, the threshold and classification likeliness score can be used to evaluate the relevance to the categories associated with a received input from a survey participant. The relevance of an input can be calculated as a percentile of a score over a threshold value. For example, if the classification likeliness score is higher than the threshold, then the Classifier model is indicating that this classification is referenced in the verbatim. If the score is lower than the threshold, then this classification is not referenced in the verbatim.

Relevance determines whether the topics covered in the content are relevant to the question being asked and the answers expected. For example, if a question in a restaurant satisfaction survey asks the respondent to describe the quality of service and they describe the quality of the meal, then this would not be relevant. Conversely, if a respondent is asked what they like about something but writes what they don't like then that answer would not be relevant.

Once a verbatim's content has been deemed to be relevant, it is measured for richness. Richness is based on understanding the detail expected to be covered within a topic. This is like an examiner marking a paper. The examiner has a list of the points that should be covered by a response; the examiner evaluates the content to see if those points are covered. For example, in response to a question asking what a person dislikes about their car, if the respondent says the seats are uncomfortable, then the points that should be covered is which seats the respondent is referring to and what is meant by uncomfortable. Without these points being covered, the response would not be considered rich.

Alternatively, a question may ask a respondent about their experience when returning a faulty product. If the respondent mentions slow response and adds also “that on each of the three times I sent an email to support, they did not respond within the 24-hour response time they indicate on the website,” this would be considered a rich response.

The category likeliness score is calculated by one or more functions. For example, a Sigmoid, known, or proprietary function can be used to calculate a likeliness score. When the classification likeliness score has been shown to exceed the threshold, the model has accurately identified a relationship between the categories defined from the Historical Open-end Data module 104 and the verbatims received from the survey. Thus the Classifier model takes an array of verbatims to be scored and outputs a full list of the categories for each verbatim with a likeliness score for each category. The Classifier returns a threshold and score for all the known classifications.

There can be one or more classifiers. In one embodiment, one Classifier is trained on dislike questions. In another embodiment, the Classifier is trained on like questions. In another embodiment, the Classifier is trained on both like and dislike questions. Each classifier has been trained on hundreds of thousands of collected verbatims from research projects. The verbatims have been coded manually after they have been collected, and the coding provides the categories used in the classifier model. Although the verbatims have been collected from around the world in a variety of different languages, each has been coded based on the same set of categories. The Classifier model accepts a verbatim as input and outputs the verbatim and a full list of categories. For each category two values are provided, the score and the threshold. This information is used elsewhere to determine which categories are relevant to the verbatim.

In a further aspect, the system 100 can also evaluate how well the Historical Open-end Data module 104 and the Classifier module 110 coordinate a relationship between the historical data and the received verbatim. In one aspect, the sample comprising about 15% of the entire set grouping of historical verbatims can be used for accuracy analysis. For example, the accuracy of the threshold determined can be automatically validated by a subroutine operating in the Classifier module 110. The threshold validation can be evaluated by calculating percentages between false positive indicators, false negative indicators, true positive indicators, and true negative indicators. False positives are classifications that were identified that were not correct. False negatives are classifications that were not identified that were correct. True positives are classifications that were identified that were correct. True negatives are classifications that were not identified that were not correct. For example, once an AI model is trained, it should be validated. One method of validating an AI model is by getting the AI model to predict classifications for verbatims that were not used in training the AI model. These verbatims have known classifications determined in the same or similar way as the classifications used in the training data (i.e., by pre-assignment or manual input). By running these verification verbatims through the AI model, the AI model outputs the classification and its likeliness score. These classifications and likeliness score(s) can be checked against the previously-determined classifications. If, for example, the previous determination of classification is “A” and the AI model output classification is “A” as well, then that AI model classification is a true positive. If, however, the previously-determined classification was “A” but the AI model classification is another value, then the AI model classification is a false negative. If the previously-determined classification was that it was not a classification but the AI model says it is, this is a false positive. If both the previously-determined classification and AI model classification result in a determination that it was not a classification, then the result is a true negative. Calculating these for each test verbatim creates an associated F1 score. The F1 score can be used to indicate whether the classifier model is performing poorly (e.g., making a sufficient correlation between the historical data and verbatims received as open-ended input). The purpose of an F1 score is to validate the quality of an AI model.

The purpose of the threshold is to validate a likeliness score and determine whether that classification should be applied to the verbatim. The threshold value can be established for each classification. The threshold value for each classification is useful because not all data is equal. In particular, the likeliness score for one classification cannot meaningfully be compared directly to the score for another classification because the classifications are different. The number of examples and the quality of data provided to the AI for training is not the same for every classification. Consequently, a threshold is calculated for every classification. If, for example, a likeliness score of 0.7 is given for classification A, and a similar score of 0.7 is given for classification B, this does not mean classifications A and B are equally likely to be allocated to the verbatim. The threshold value can be used in conjunction with the likeliness score to determine if classification A and/or classification B is indeed relevant to the verbatim.

As mentioned earlier, the F1 score can be used to indicate whether the classifier model is performing well. The threshold validation can comprise the formula: F1=(Precision*Recall)/(Precision+Recall). In this formula, the precision variable can be defined as: the number of True Positives divided by the number of True Positives and False Positives. The Recall variable is defined as the number of True Positives divided by the number of True Positives and the number of False Negatives. When the F1 score for a category was high (over 0.85), then the classifier was deemed to perform well for the category. Where the F1 score was low (under 0.15), the classifier model 110 was performing poorly.

Here, the F1 score helps define the quality of the AI model output by comparing the output from the AI model to determine the optimal threshold level for each classification. The F1 score is iteratively recalculated (e.g., using a step function, or by setting a recalculation interval, or a recalculation trigger), and the current threshold associated with a classification is also recalculated (e.g., to complete a step function, to meet a recalculation interval max, or to meet and recalculation end point). The optimalF1 score (e.g., the best F1 score for the desired conditions or classification, or the latest F1 score with the highest value, or meeting some other desired criterion or preference) is used in a formula to recalculate and update the threshold. The threshold corresponding to the optimal F1 score is then defined as the current threshold. If the threshold is correct, then each likeliness score provided by the AI model should fit above or below the threshold in such a way that there are only true negatives and true positives, and no false negatives and false positives (1.0 on the F1 score). For example, a classification A output with a likeliness score of 0.7 should correctly indicate when the classification is attributed (giving a true positive) to a verbatim, and never incorrectly indicate when the classification is attributed (resulting in a false positive). Equally the Classifier model should correctly not allocate a classification (upon encountering a true negative) to a verbatim and conversely, should not (upon encountering a false negative) give an incorrect indication that an allocation is not present when the model was supposed to allocate the classification to the verbatim.

In yet another aspect, a second level of validation of the threshold can comprise a verification user interface. The system can include an optional manual verification interface, which enables, for example, researchers to verify the quality of the verbatim. Such an option can help act as a secondary check on the automated threshold verification, and can confirm correlation to real-world accuracy. For example, a survey interface can allow a researcher to enter a known new, coded verbatim (i.e., one not used in the original training or automated threshold verification) and to see the list of expected verbatims and the top ten classifications that did not match the verbatim. With each expected verbatim and top ten classifications that did not match the verbatim, a checkbox is provided. The researcher can use the checkboxes to indicate which categories they believe are relevant for the verbatim. In this manner, the checked values of the manual verification can be used to generate new training data, further train, and improve the quality of the verbatim.

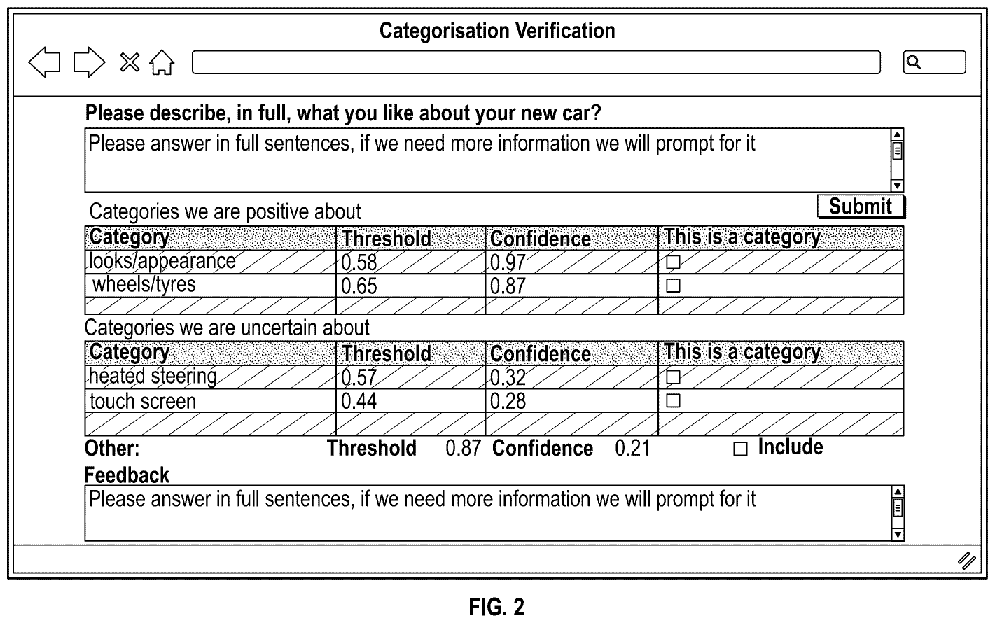

For example, as shown in FIG. 2, the optional manual verification interface comprises columns of the scores between categories that a participant makes to provide information. As depicted, the last column displays a request to determine if the displayed categories are accurate in the participant view. The participants can provide an assessment by checking that categories can be used to further train the classifier model.

For optimal results, all the categories identified by the AI are selected by the researcher and none of the categories not identified by the AI are selected. FIG. 2 also depicts a comments box at the bottom of the screen that allows the researcher to explain any variance from the perfect score.

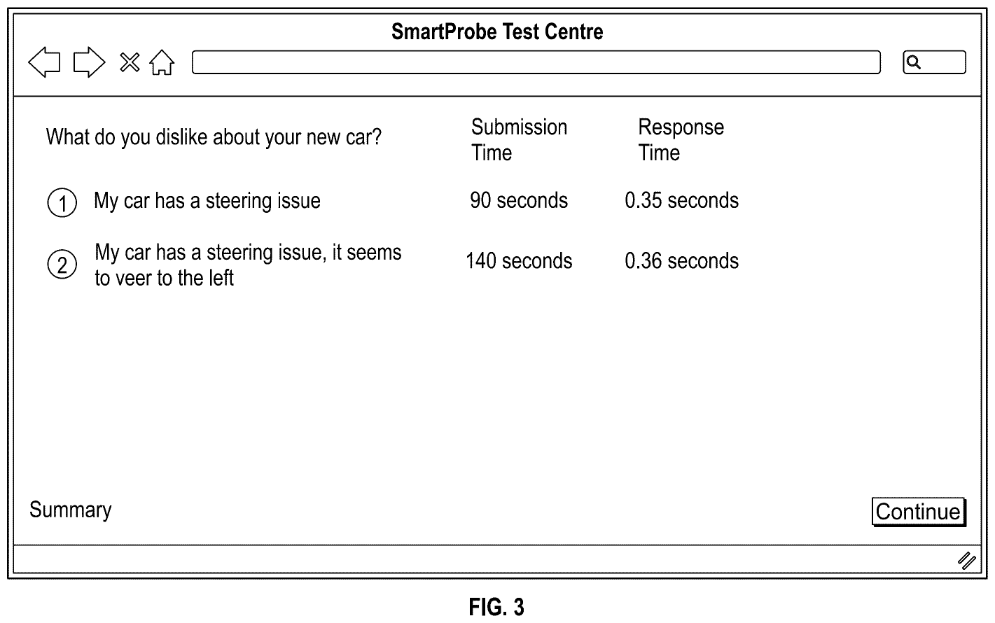

In another aspect, the system can also generate additional graphics to evaluate the efficiency of the system. For example, the system can generate a user graphic that evaluates the operation of the flow of data from the Front-end and the Back-end AI models. As shown in FIG. 3, each respondent input can be analyzed and extracted from the Javascript Object Notation (JSON) responses from the AI models. The graphic can display the text submitted to the survey via the front-end; the submission Time (to the AI model); and the response time (from the AI model). In a further aspect, the graphic can display the response submitted in chronological order based on the submission time.

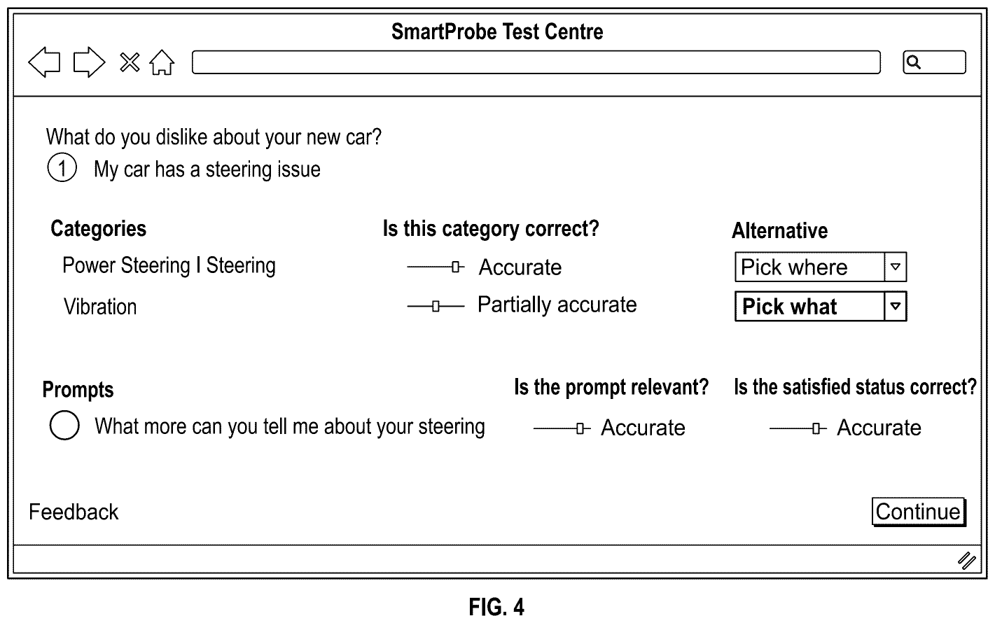

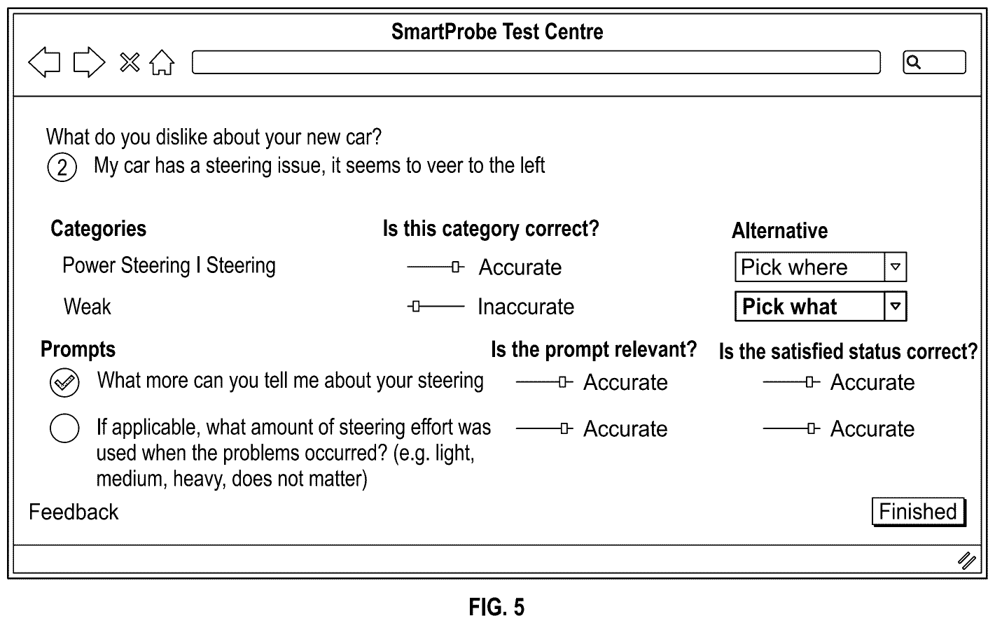

The user can further assess the operation of the survey by providing feedback on the probes and categories associated with the open-ended data input, as depicted in FIG. 4 and FIG. 5. On the interface page, the user interface can display at the least 1) Sequence Number (Interaction 1, 2, 3, etc.), 2) Time spent between interactions, 3) Time taken to complete interaction with AI, 4) The text that was submitted, 5) The Categories that were returned, and 6) The Prompts that were returned and whether they were satisfied. The user can then rate each element (both categories, each prompt and whether the prompt was satisfied) with a 3-point scale (Accurate, partially accurate, inaccurate). When a category is identified as only partially accurate or inaccurate, then the user will be allowed to select an alternative from a list of categories. In this feedback study, each of the sliders is a 3-point scale with inaccurate and accurate having the values 1 and 3 respectively. In other studies, the sliders could be set with other scale values. When the value is anything other than the highest, accurate value (e.g., 3), the Alternative drop down should be enabled. Each category has a different set of options within the dropdown which is defined by a list of categories that the business can provide during development. As shown in FIG. 5, the user can also identify and indicate their view of the accuracy of prompts. The list of prompts can contain any satisfied prompts and the first unsatisfied prompts. Any additional unsatisfied prompts could be optionally displayed. The number of prompts and their status will change from transaction to transaction.

The data flow system can further comprise a QA Model 110. The QA Model 110 accepts a verbatim from the participant received from the Front-end Web Content Platform 118. The QA Model 110 can also identify probes and follow up questions that can be associated with a received input. In a further aspect, the QA Model 110 can determine whether the probe is satisfied by the verbatim. In another aspect, there may be several probes to check against a single verbatim, and consequently the QA Model 110 is executed multiple times for each one classifier execution. To determine the accuracy, the QA Model 110 can generate a plurality of scores.

| | |
|---|---|
| The input: | A verbatim |
| | A list of probes |
| The output: | A list of probes |
| | A Yes/No indicator for each probe |
| | An extract of the verbatim that satisfies the probe |
| | A start and end position for the extract |

As shown in FIG. 1, the data path of the two AI (artificial intelligence) models operate independently of each other. An additional component, the middleware 116, operates between the front-end, presented to the respondent, and the Historical Open-end Data module 104 and the Research Domain Knowledge 106 module. The middleware module 116 can communicate with the Front-end Web Component module 112. The middleware 116 looks up each category in a threshold table, to obtain each category's threshold and then determine which categories match by identifying the scores that exceed their threshold. For each matched category, the system looks up the category in a database to obtain a list of probes. For each of these probes, the middleware 116 makes a call to the QA Model 110 passing the verbatim and the probes. The QA Model 110 returns both with a score indicating the likeliness to be satisfied, along with the section of the verbatim that satisfies the probe. In one aspect, the middleware comprises a Business Research Logic 114. The Business Research Logic 114 can be a module or supporting software configured to receive verbatim from the Front-end Web Component module 112. The Business Research Logic 114 can communicate with the AI Classifier 108 providing this verbatim for evaluation. The output of the AI Classifier 108 is the same verbatim as all the categories with their scores. Finally, the middleware compiles a new output to return to the web front-end, this contains: 1) the verbatim, 2) each of the matching categories, their score and threshold, and 3) the probes for each category indicating whether they were satisfied.

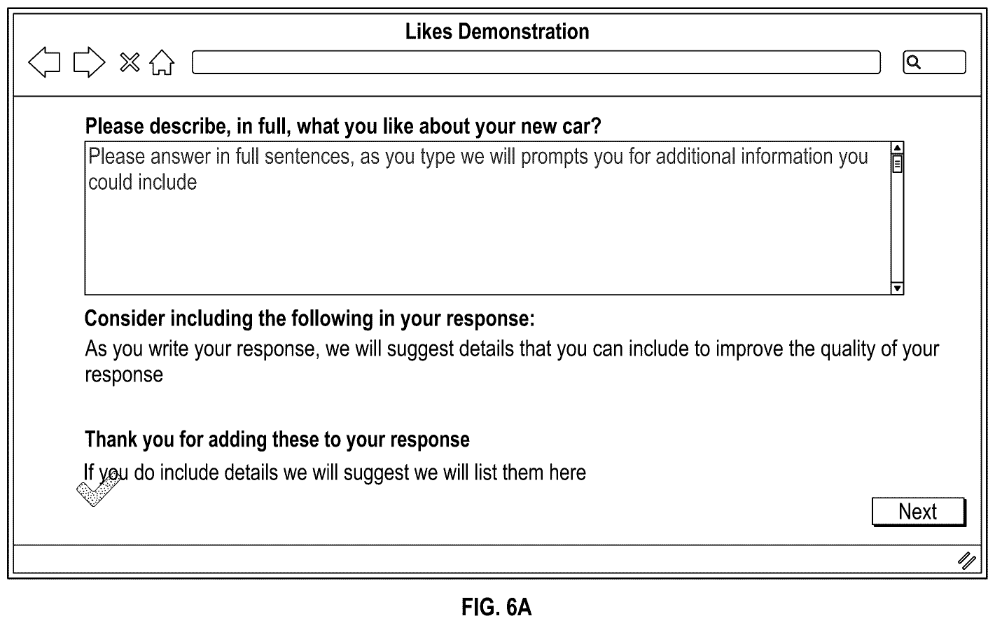

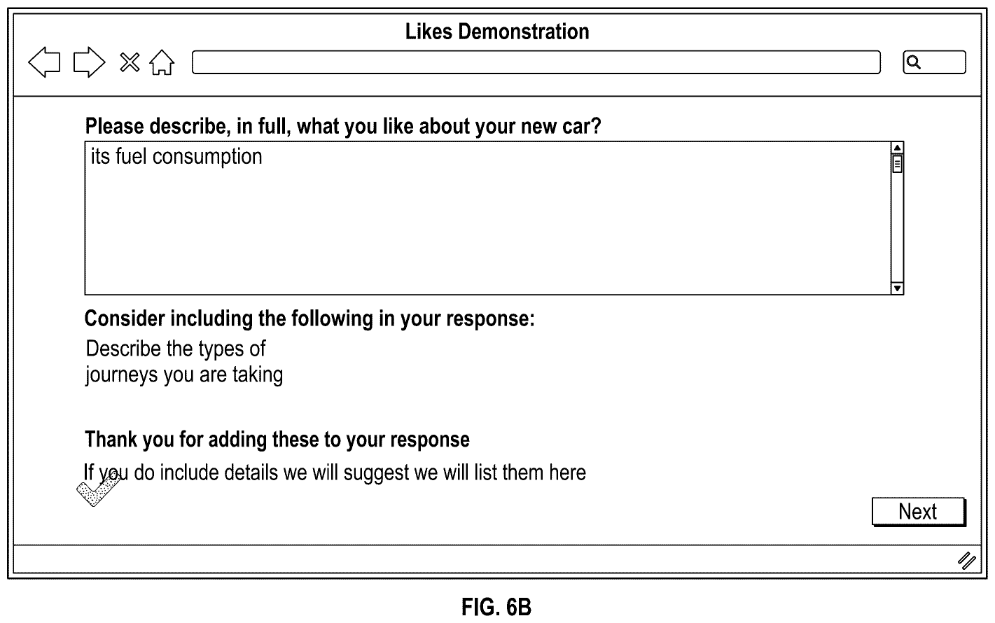

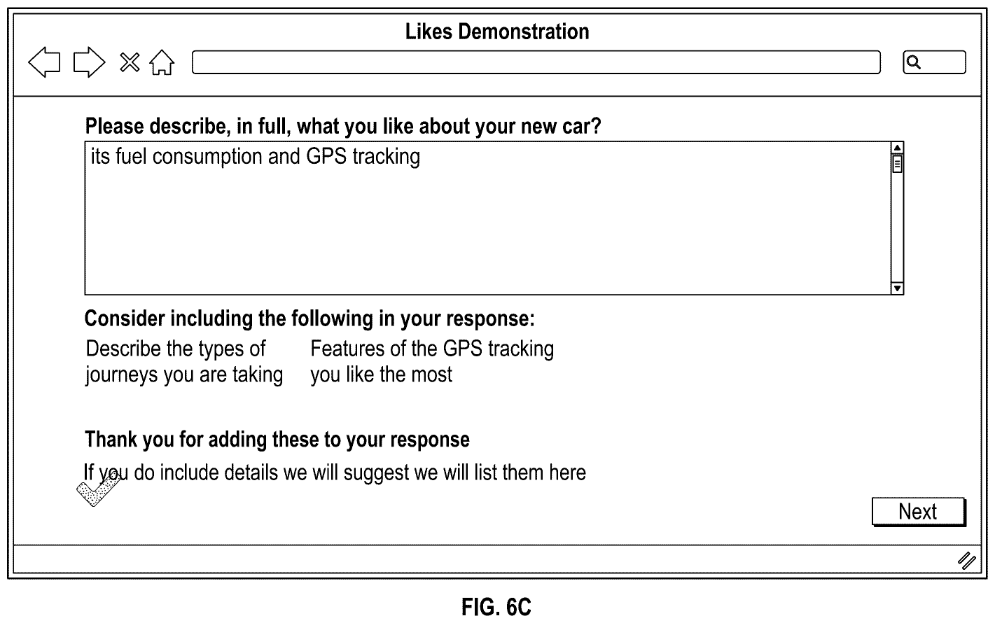

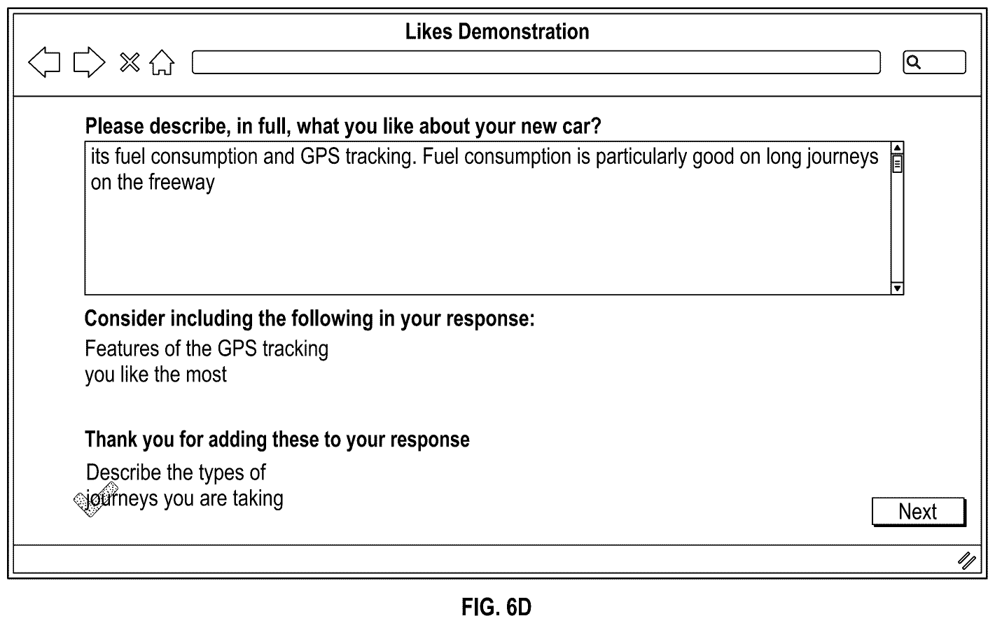

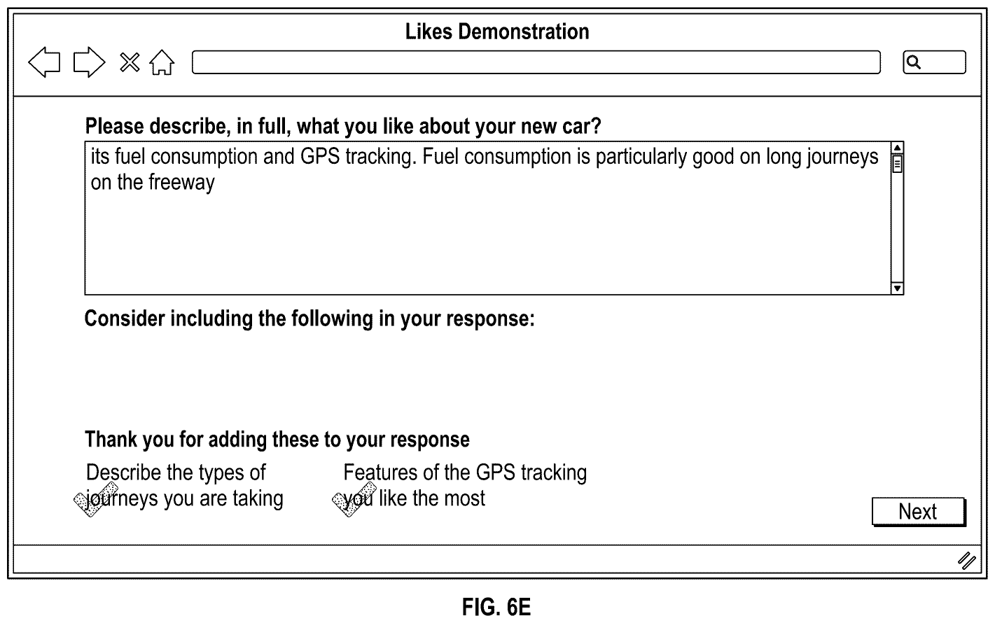

As shown in FIGS. 6A-6E, the user interface encountered by a survey participant can be hosted in the Front-end Web Component module 112. An exemplary survey platform or application can be used to host online quantitative surveys. In one aspect, the platform can be embedded within Askia. For example, an Askia Design Component (ADC) can be constructed that allows a researcher to easily deploy the facility requiring only a URL to the middleware and a definition of the type of question being evaluated (currently Likes and Dislikes). Further, ADC can inject HTML into the survey at run time providing the respondent with the question and an augmented open-end, multi-line input box, into which they can answer a response, as depicted in FIGS. 3A-3E. The layout can in one embodiment be optimized to operate for mobile devices, but has capability such that it will operate on any device that supports a browser.

As depicted in FIGS. 6A-6E, the user interface for the survey prompt to receive the open-ended input can comprise a basic multi-line input control (text area). In one aspect, the grey text can be a preliminary prompt for the user that will disappear or be replaced as the user types or pauses their typing.

In a further aspect, this interface can comprise additional capabilities. For example, the interface for most open-end questions has been augmented in two ways: 1) an icon representing the current status of the module or 2) a probe area where probes are displayed as required. Non-exhaustive examples of status include idle, thinking, and success, where success means that all probes have been satisfied. The probe area can display to the respondent the probe that could inspire the respondent to provide additional depth to their response. For example, as depicted in FIG. 3B, the prompt area displays “describe the types of journeys you are taking.” The prompt area can be augmented, as depicted in FIG. 6C, to include, “Features of the GPS tracking you like the most.” Further, when the respondent provides a suitable response that the system perceives a particular probe to be answered, the system will provide an icon (e.g., a checkmark) next to the probe, as depicted in FIGS. 6D and 6E. This icon can provide a visual indicator to the respondent that their input addresses the request of the system.

In a further aspect, the system supports receiving both single statements and multiple statements. With either a single statement or multiple statements in the text area, the middleware of the system can identify multiple categories, wherein the multiple categories can be associated with multiple probes. The applicability of the probes can be scored or used by the system subsequently added to the probe area in the user interface, as depicted in FIGS. 6A-6E.

The additional layer of functionality that is separating all the content into individual statements will be based on AI. There are two key steps that this AI can execute including: 1) Co-reference resolution and 2) Aspect Extraction. Co-reference resolution can comprise finding all expressions that refer to the same entity. For example, the respondent can indicate “the color of my car is blue. I really like it,” which is interpreted and processed by the system to become “the color of my car is blue. I really like the color.” Aspect Extraction of the respondent's input can include identifying and extracting terms relevant for opinion mining. For example, the AI model can search terms for product attributes or features. The AI models can then combine the extracted terms and combine the extracted terms with neuro-linguistic programming (NLP) techniques (such as entity recognition). The aspect extraction technique can allow for the extraction of statements, regardless of whether they are contained in a single sentence or multiple statements. The aspect extraction technique may even be able to recognize situations where multiple sentences (not conjoined) are describing the same issue in different levels of detail. For example, Aspect extraction across multiple sentences can involve, in one iteration, pronouns and how a pronoun in one sentence relates to a noun in another. For example, a respondent could input: “I love the mileage I get from my car. It's particularly good around town.” The system would recognize the complexity is in multiple classifications. If a respondent inputs: “The indicators are large and easily seen, the headlights are bright and clear. They are particularly effective on quiet country roads.” In this instance, it would be important for the system to understand the term “they” in its relation to headlights and not to indicators. As another example, that shows more complexity but which the system can also handle, the respondent could input something like: “I love the way people look admiringly at gold calipers on the brake pads. They made me feel very proud.” Here the system would have to determine whether “they” is referring to the people or the brake pads.

The user interface configuration also allows the definition of placeholder text for the text area (displayed when there is no response) and placeholder text for the probes area (displayed when there are no probes). In an aspect, the Front-end Web Component module operating the user interface is configured to communicate with the middleware and back-end in multiple languages. For example, the system can support multiple languages, including but not limited to: English, French, German, Spanish, Portuguese, Chinese, etc. The system can be configured to update the back-end AI models to account for the nuances of particular languages and adjustments required in respective probes. In another embodiment, the system can respond to user input in a first language, but react to multiple language input by subsequently responding to user input in different languages. For example, if a user indicates at the start of a survey that their preferred communication language is English, the probes will be provided in English. If, however, the user starts providing verbatim responses in Spanish, then the probes will be provided in Spanish to match the respondent verbatims instead of the previously requested language of English. Further still, if the respondent resumes responding in English, or even another language, then the probes would responsively be provided in English, or the other language.

In yet a further aspect, the question to the respondent, when presented, is optional in terms of whether the respondent needs to answer the question. That is, the respondent can choose not to answer the question and select a Next button, which allows the respondent to move to the next question. In this manner, the respondent gets to choose whether or not they believe the question is relevant and/or a question they wish to answer. Thus, the system is looking for unprompted responses; while it may ask follow-up questions it does so passively. The respondent does not have to provide an answer.

In yet another further aspect, the system encourages the user to adjust their initial response in any way. No earlier response is locked, and the responses remain editable. Thus, the respondent can add more information or adjust one or more response(s) already given. Each time the system evaluates the response, it evaluates the entire response (for all historical responses by that respondent in the session) and not just what has changed.

The evaluation of the open-ended input can be continual. For example, for every x number of characters received from the user interface, the platform running on the front-end can initiate a conversation with the middleware. In a further aspect, additional characters can reinitiate the communication between the front-end and middleware. Reinitiating the communication can be determined by a combination of respondent language and question configuration. Further, once typing has started, if there is a pause in keystrokes for y milliseconds (where y is a value configured within the question), then the respondent is deemed to have temporarily stopped typing, either to think or because they have completed their response. In this manner, real-time evaluation is provided, and challenges of knowing the right time to evaluate in real time are addressed. Such responsive continual evaluation resolves evaluation issues, since after the respondent has answered the question and moved to the next one it is too late, even if a respondent is still accessing the survey, and evaluation each time the user presses a key is too soon or too often, and will cause the system to misunderstand the incomplete entry and behave erratically, in a manner that will influence the survey progress and may frustrate the respondent in a manner that impacts further responses, relevance, or richness. Finally, the whole verbatim is assessed whenever there is a change in the content of the verbatim, whether a stoppage in typing, deleting, cutting, copying, or pasting. If the number of characters changed is greater than z (where z is configurable within the question, e.g., 5 characters), then the front-end initiates a conversation with the middleware. An indication of completeness recognized by the front-end can trigger the middleware to identify probes associated with the input and/or also determine if a probe had been satisfied if the survey has progressed beyond an initial question. Each time a conversation is initiated, the current entire verbatim is recorded and assessed. Further comparisons and character counts are based on this entire recorded verbatim.

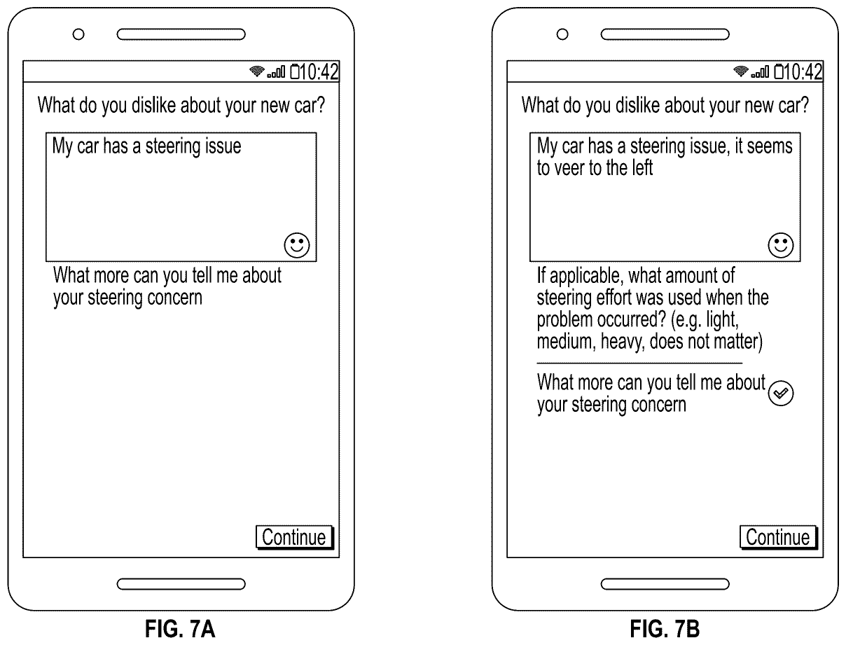

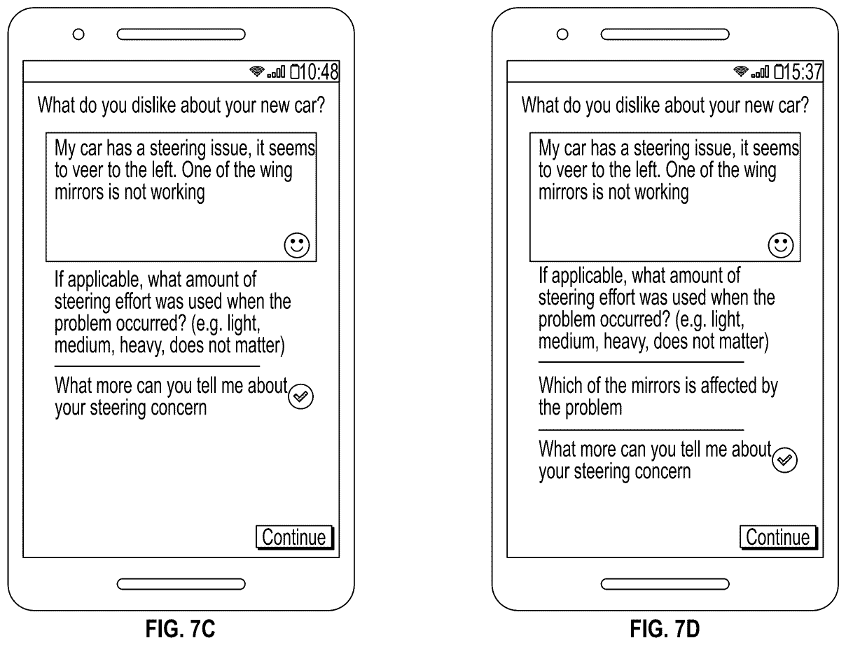

In another embodiment, the system can comprise an interface that is configured for a mobile device. The previously-described question/open-end combination provides the user a general question prompt and the opportunity to write as much or as little as they like. Answering the question is optional and so the continue/next button is always enabled for the respondent user to be able to skip the question if desired. Once a respondent inputs their answer to the question, the system analyzes the input and provides prompts responsive to the statement, with prioritization of the prompt depending on the input provided. See, e.g., FIG. 7A with one statement inputted by the respondent and a responsive prompt relating to steering, and FIG. 7B with two statements inputted by the respondent, where the second statement “it seems to veer to the left” satisfies the initial responsive prompt of FIG. 7A, such that an indicative mark, e.g., a checkmark or tick is applied in FIG. 7B to denote that the prompt has been addressed. As depicted in FIGS. 7A-7D, based on the respondent's input of both “My car has a steering issue, it seems to veer to the left.” and “One of the wing mirrors is not working” to the general question of “What do you dislike about your new car?,” the system initiates prioritization for two prompts for different statements. One way to resolve prioritization between the prompts is by position, so that prompts relating to statements earlier in the content are displayed first (e.g., as seen in comparing FIGS. 7C and 7D as the unanswered prompt regarding steering effort is displayed before the unanswered prompt regarding which mirror is affected, since the respondent first inputted a statement regarding the steering before inputting a statement regarding the mirror). For unsatisfied prompts, the system only selects the most important prompt for each statement. Therefore, there is only one unsatisfied prompt per statement displayed at any one time. For satisfied prompts, all satisfied prompts could be listed, or this could be restricted to show only the last satisfied prompt for each statement. As prompts are satisfied, they are given a marker showing satisfaction and then are moved to the bottom of the list. This will give a visual impression and indicate to the respondent that the list is prioritized.

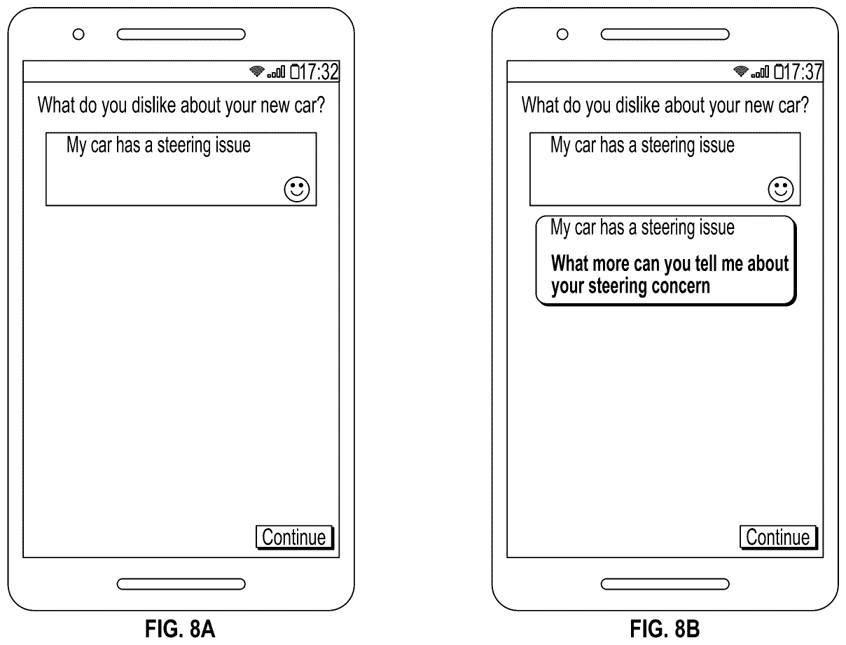

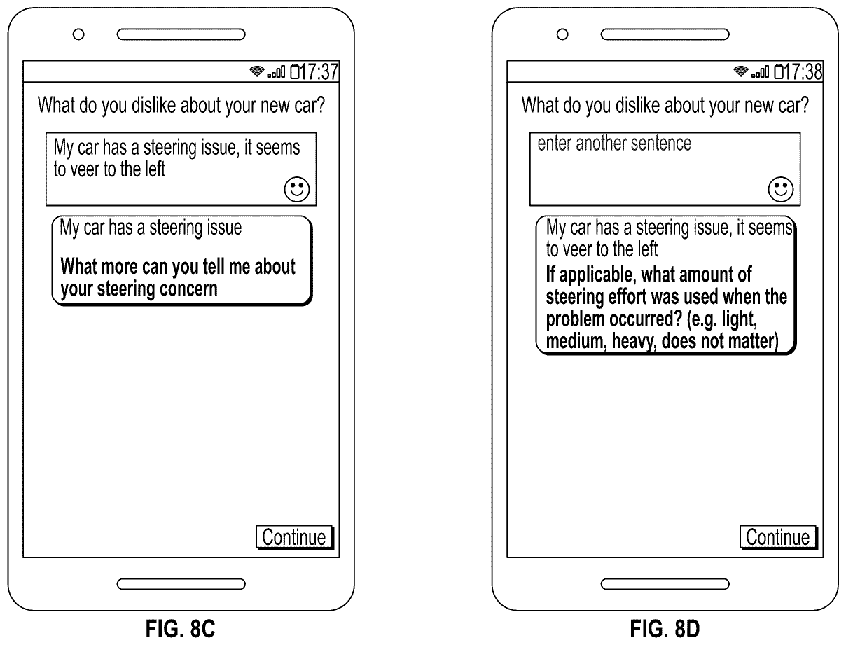

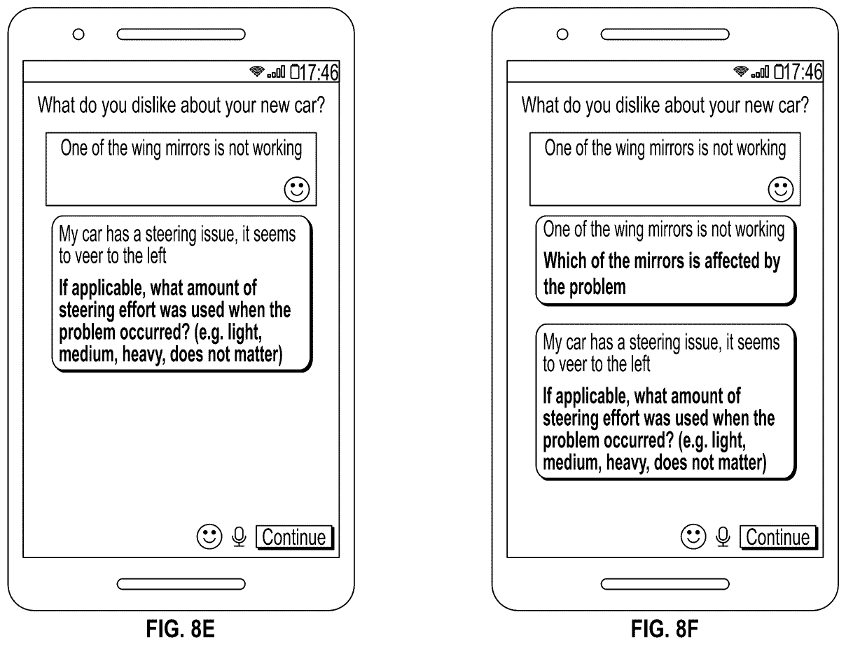

In another aspect the user interface can be configured to accept one input at a time. As depicted in FIGS. 8A-8F, the UI encourages the respondent to provide one statement at a time. The input is now approximately the size of a typical detailed sentence (see, e.g., FIG. 8A), rather than a detailed paragraph (see, e.g., FIG. 7A). This size reference is intentional, to nudge the respondent into thinking they need to provide less information. When the respondent types and pauses, the previously-described interaction takes place with the system analyzing and identifying the number of discrete statements that are contained within the respondent's inputted statement. For each discrete statement found, the system creates a card; this is displayed below the input (see, e.g., FIG. 8B). The card includes the content that the system identifies as being part of the statement (e.g., in FIG. 8B regarding the respondent's “steering concern” relating to “a steering issue”). The statement and subsequent user inputs are processed in the above-described manner, with responsive prompts (see, e.g., FIGS. 8C-8F) resulting in a categorization, prompt, and satisfaction score determined by the system in the analysis of the inputs. These are processed so that the most relevant prompt is displayed within the card next to the identified statement (see, e.g., groupings of respondent statements and related prompts in cards of FIGS. 8B-8F), and as previously-described, prompts can be updated as needed by unanswered prompts.

When the respondent continues to type and completes the sentence, presumably in reaction to the prompt displayed, then the system repeats the process, e.g., in the FIGS. 8A-8C depicted, by the use of a comma and ending phrasing. The statement evaluation process recognizes grammar and uses grammar to determine when a respondent might be changing topic. The system identifies a new first statement, sends the new first statement for evaluation and returns with the next prompt (e.g., FIG. 8D). The input is designed to allow the respondent to write a single sentence. Therefore, the preceding sentence is removed from the input (although it can still be seen in the cards, e.g., FIG. 8D). As cards are displayed in reverse order to the order in which they were last updated, the text removed from the input will always be in the card immediately below the input. The respondent is now free to enter their next sentence (e.g., FIGS. 8E, 8F). Sentences and statements are not synonymous. A sentence is a grammatical construct that may include multiple statements. Equally, a statement may be covered by more than one sentence. Although cards are used in this depiction, this interface can be made with other forms of textual input boxes, or visualizations to denote and indicate text input to users and respondents.

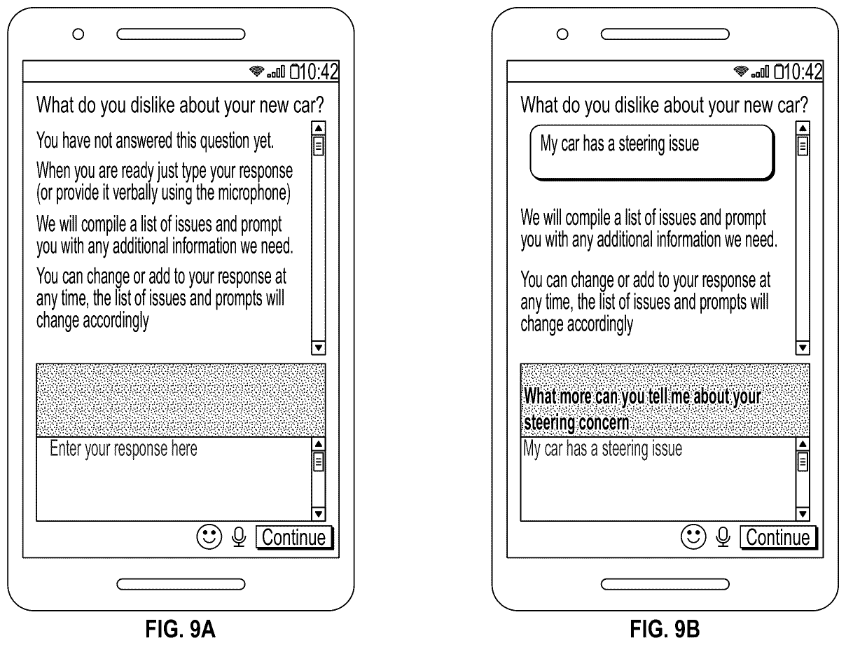

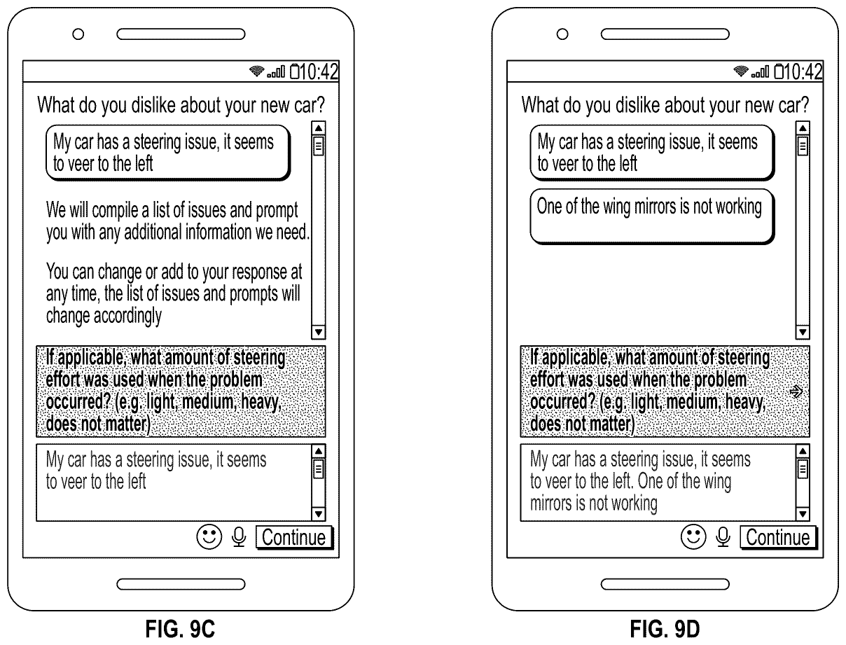

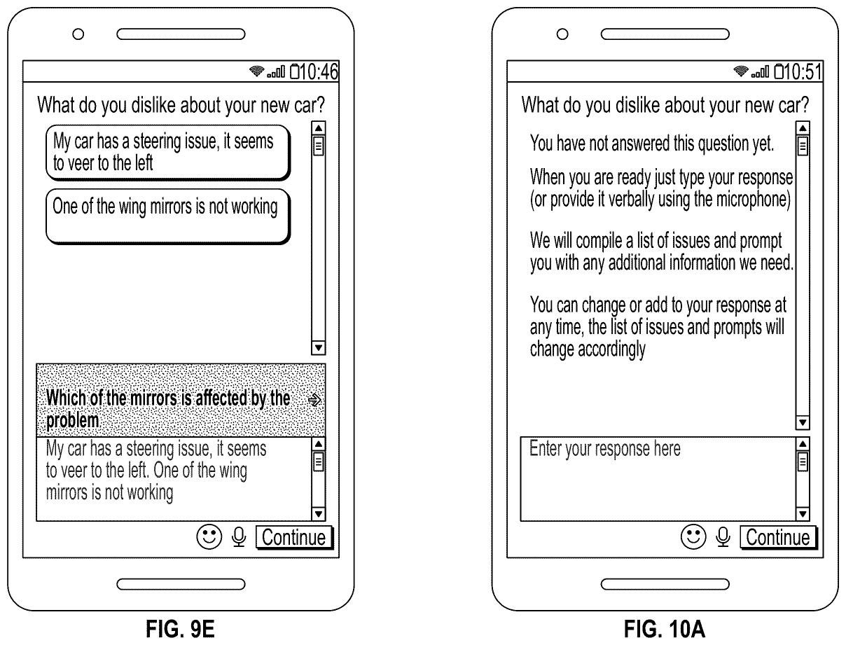

In another embodiment, the UI can be adjusted to provide additional tracking capabilities. As depicted, in FIGS. 9A-9E, the text interface has been moved to the bottom of the UI and to provide the capability to monitor the progression of the inputs. This is more typical of a chat like interface where the entry point is at the bottom and each chat element appears above the entry as it is created. This embodiment provides clarity on the statements that have been identified within the entry. When the respondent first arrives at the question, the space between the question and the input is filled with instructions. These are removed as statements are identified. The design places the prompt next to the input to increase the opportunity for the respondent to see it as they glance at the input to check their typing. Each time the system evaluates the content of the input and the resulting prompts, the most relevant prompt is identified and displayed. In one aspect, the grey text can be a preliminary prompt for the user that will disappear or be replaced as the user types or pauses their typing.

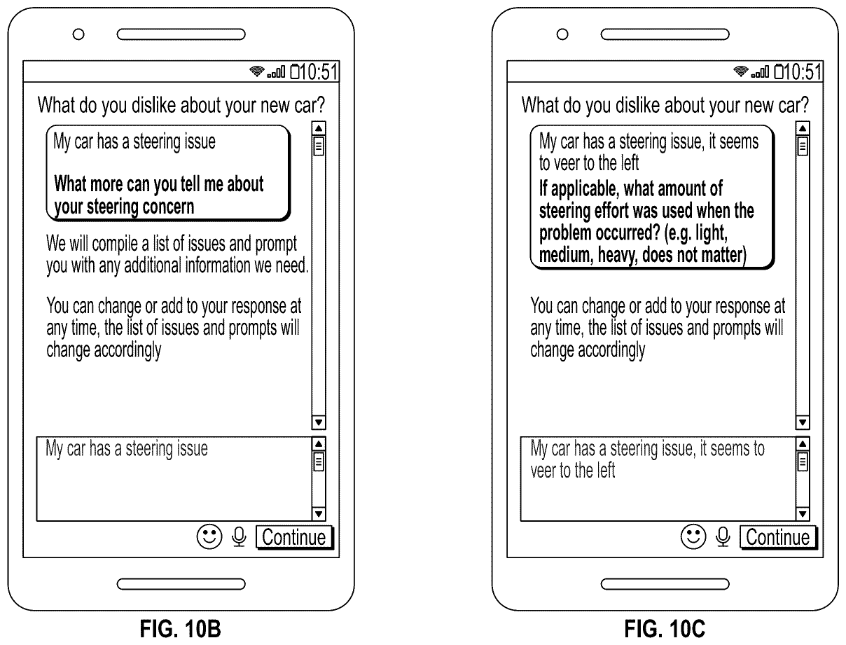

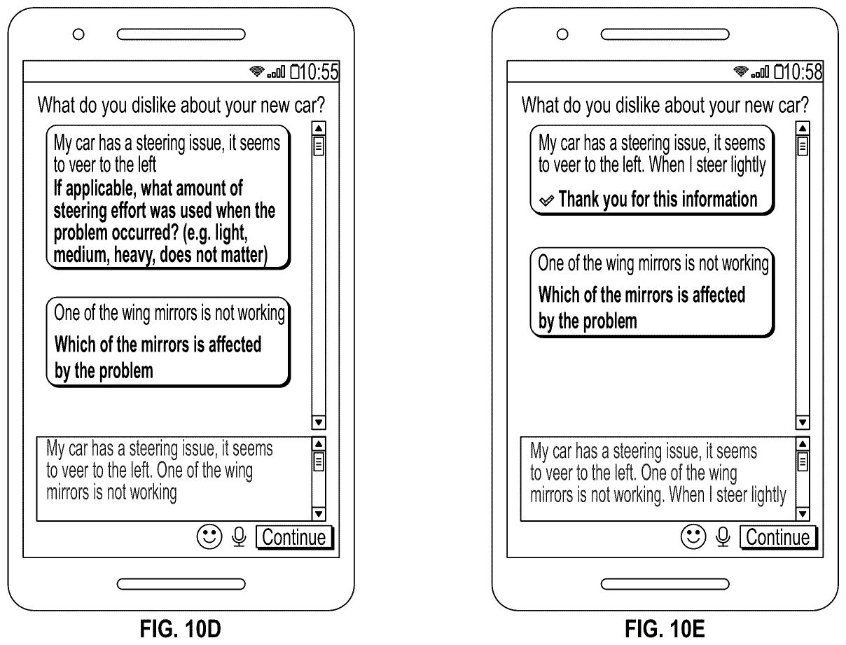

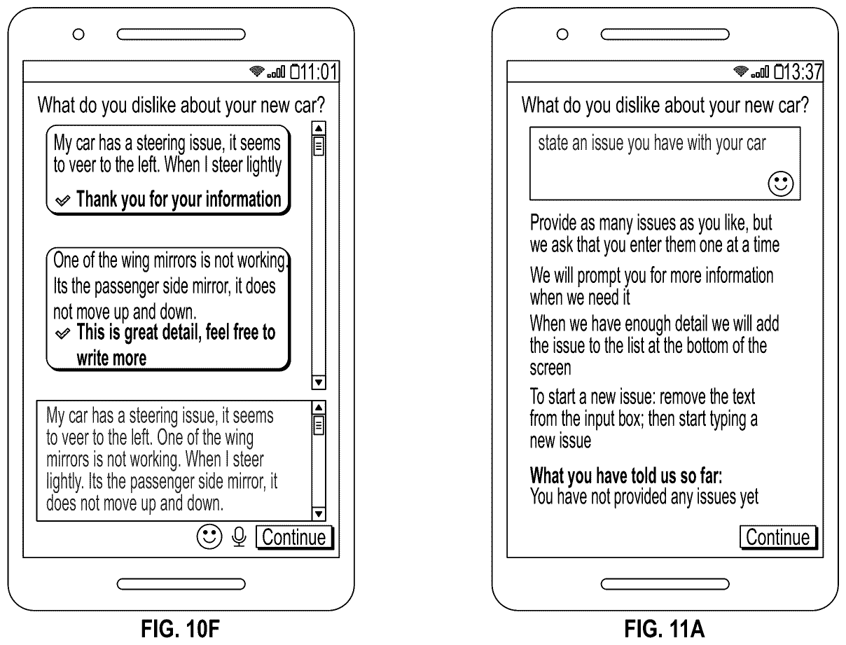

The UI can also comprise a combination of other embodiments. As depicted in FIGS. 10A-10F, the question can be at the top of the screen, and the input at the bottom. The initial screen is filled with instructions to inform the user on how to complete the question. In this embodiment, when a statement is identified and a card is created, the most important, unsatisfied prompt for that statement is displayed on the same card, rather than just above the input. While this means the user has to look further to see the prompt, it is hoped that the appearance of the card will cause the user's attention to shift and for them to read the associated prompt.

As they continue to type, the system evaluates the statement and when prompts are satisfied it changes the prompt displayed. This may be more difficult for the user to spot and so as a prompt is satisfied, a tick will appear and then the satisfied prompt and tick will disappear to be replaced by the new prompt. This simple animation should help the respondent understand the content of the card has changed. If the respondent provides more than two statements, the system will create multiple cards. The most relevant unsatisfied prompt will be displayed for each statement, supporting multiple statements and prompts. The cards will be displayed in reverse order of the last detected change so that those statements that have changed most recently are listed at the top.

When a statement is fully satisfied, the area for the prompt is no longer required. The system replaces it with an encouragement. This is in the form of a checkmark followed by a statement. The checkmark clearly shows that the statement is complete and encourages the respondent to write more statements. These statements will be displayed at the bottom of the list of statements; an animation will see the card move once the card prompts have been fully satisfied. In one aspect, the grey text can be a preliminary prompt for the user that will disappear or be replaced as the user types or pauses their typing.

While the intention is that the user only types on the keyboard, so that their focus is on providing more information, a scrollbar will be provided (when required) to allow users to scroll up and down the list of issues. This will help if user inputs create a shopping list of issues resulting in the creation of multiple cards in quick succession.

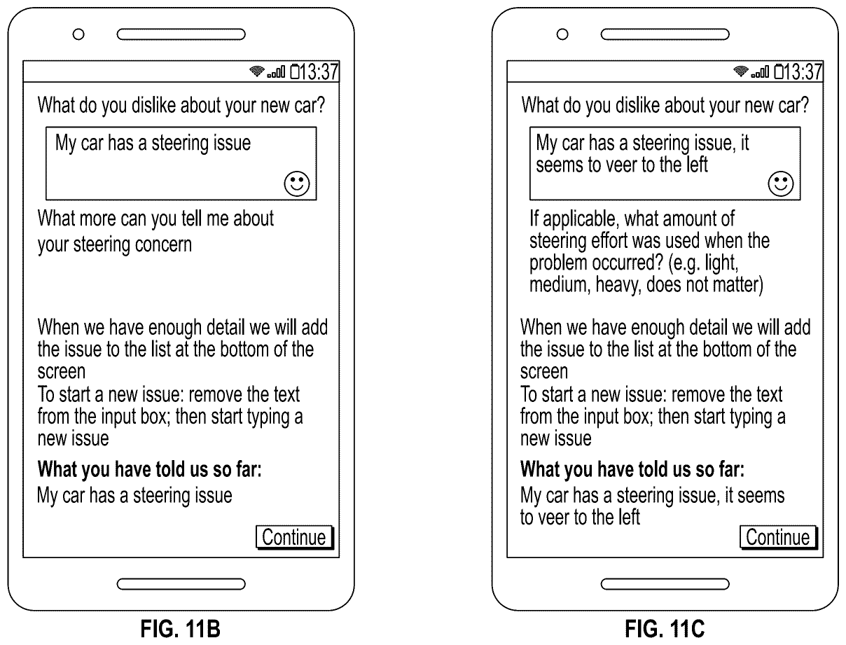

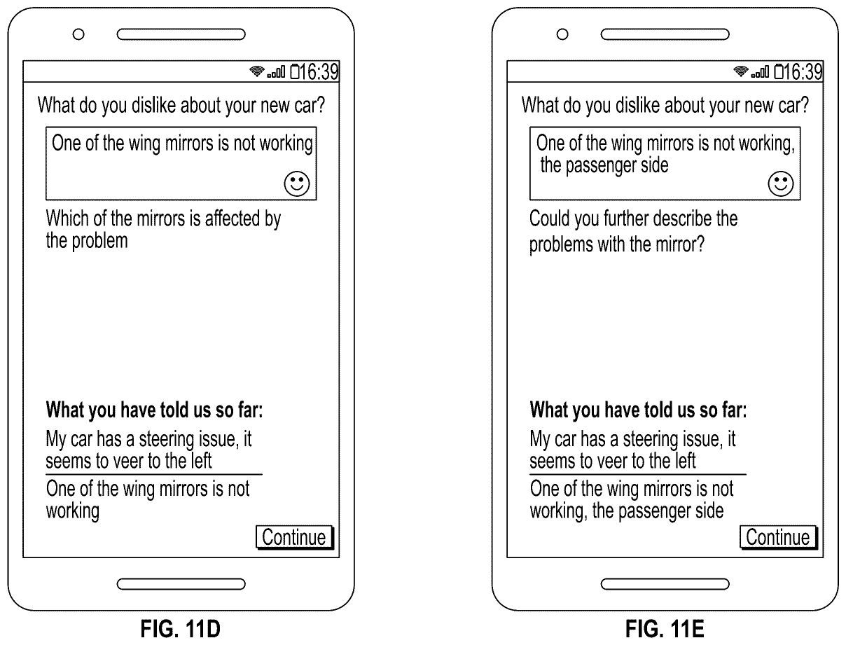

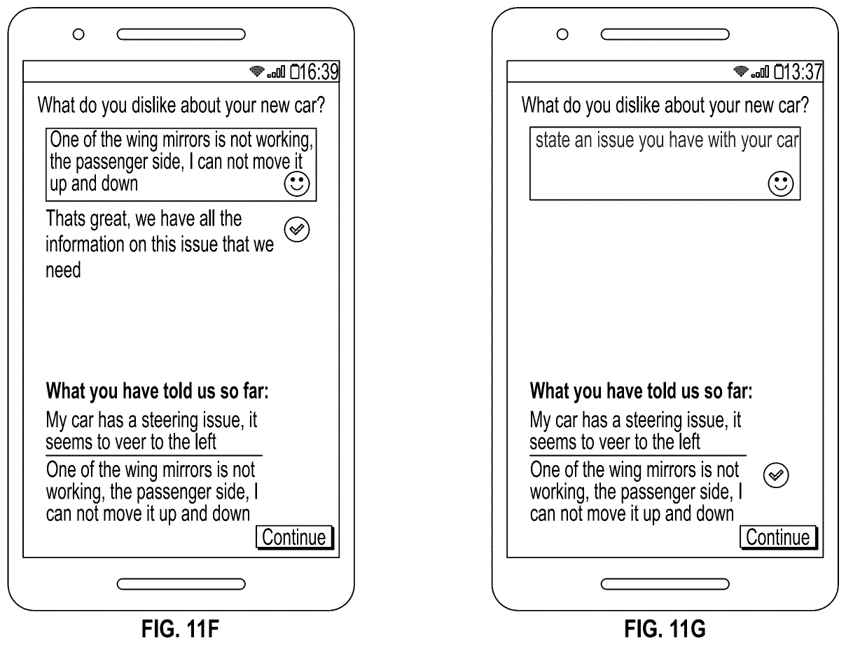

In yet another embodiment, the system can manage the UI through controlled single statements. As depicted in FIGS. 11A-11G, an input area has been reduced in size to encourage the writing of single sentences rather than complex paragraphs. The increased white space on the page is used to provide instructions to the user. At the bottom of the page is a space reserved for a history of statements that the user has made. When the user types, the system listens for a pause. When the pause occurs, the system looks at the content and compares the content to the previous content to determine whether the content is similar. For example, between successive figures (e.g., FIGS. 11A and 11B, 11B and 11C, 11C and 11D, 11D and 11E), the content is not similar because there are addition(s), whereas at the point displayed in FIG. 11G the content is similar as the starting point. When the content is found to be not similar, it is identified as new content and so the new text is sent to the AI layer for evaluation.

The AI layer returns with a classification of intents and a set of prompts. At this point the system copies the content sent to the history at the bottom of the screen (e.g., FIG. 11B). As all the prompts are not satisfied, the most important unsatisfied prompt is displayed just below the input with instructions removed to make space for the prompt (e.g., in FIG. 11B “What more can you tell me about your steering concern”). Either after the system analysis exchange takes place or during it, the respondent enters more content. When there is a second pause in the typing, the system compares this content to the previous content. The system confirms whether the respondent has added to the original content. There is a second analysis exchange initiated with the AI. Each analysis exchange provides the full content of the input, not just the new content. The AI evaluates the content and returns with classifications, prompts and satisfactions.

As the classification returned is the same as the one returned previously, the history is updated (e.g., FIG. 11C, adding “it seems to veer to the left” to “My car has a steering issue”). The prompt in the history now shows the latest content (e.g., FIG. 11C, “What you have told us so far: My car has a steering issue, it seems to veer to the left”). One of the prompts is now satisfied and so the first unsatisfied prompt has changed; this is displayed under the input, replacing the old prompt (e.g., in FIG. 11C, “If applicable, what amount of steering effort was used when the problem occurred?”). This would continue if the respondent was to type more content based on the second prompt. But what if the respondent does not want to provide more information, but they do want to enter a second statement? To do this they remove the first statement from the input (e.g., FIG. 11D, deleting the steering-related typing). This removal will naturally cause a pause in entry, but the system will recognize that there is no content in input and so will not send anything to the AI during the user removal interaction. Once the respondent types a second statement (and pauses) the system will recognize this as being different from before and will send the statement to the AI. The returning classifications are different and so a new item is made in the history (see, e.g., FIG. 11D). The most important unsatisfied prompt is displayed under the input.

As before, the respondent can react to the prompt providing more information. If more information is provided, the information is sent to the AI for evaluation of whether to return a satisfied and/or an unsatisfied prompt and modify the prompt. If the respondent adds more information to satisfy the second prompt (e.g., FIG. 11E, adding “the passenger side” to “further describe the problem with the mirror”), then the returning AI will indicate two satisfied prompts. The respondent has provided all the information required for this statement. An indicator (e.g., a check or other mark) shows that the detail is sufficient (e.g., FIG. 11F, “That's great, we have all the information on this issue that we [need]”). The statement in the history is also shown with an indicator to show that all the detail entered is sufficient (e.g., FIG. 11G, with a check or other mark by the corresponding statement). In one aspect, the grey text can be a preliminary prompt for the user that will disappear or be replaced as the user types or pauses their typing. At this point the system empties the input box, which causes the placeholder to be displayed. The system is now ready for the respondent to enter a third statement. Once the respondent enters a third, or subsequent statement, similar processes as discussed above would occur, and be iterated through, to process, analyze, and respond to the statements. In this way the system processes user statements and assesses whether they individually or together are complete answers to a question posed.

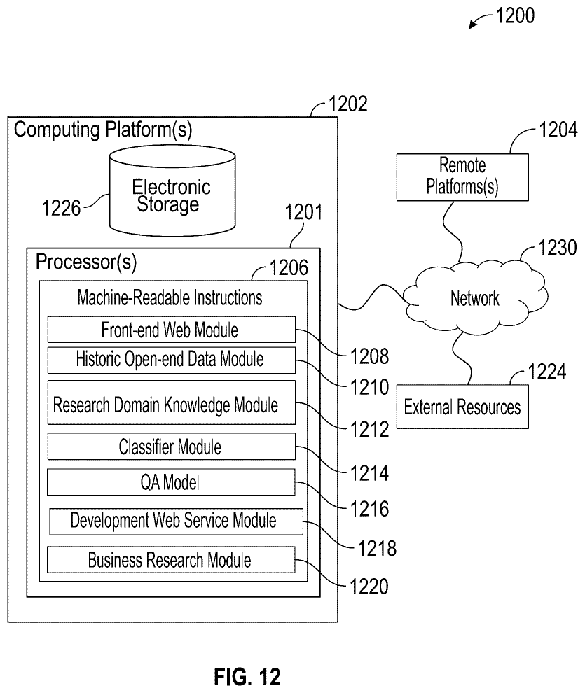

FIG. 12 is a block diagram illustrating an example computer system 1200 (e.g., representing both client and server) with which aspects of the subject technology can be implemented. The system 1200 may be configured for managing open-ended data inputs. In some implementations, the system 1200 may include one or more computing platforms 1202. The computing platform(s) 1202 can also correspond to a server component of a communication platform and include the processor. The computing platform(s) 1202 can be configured to store, receive, determine, and/or analyze user preferences (e.g., communication preferences) and/or user information to determine encrypted content and non-encrypted content in the communication environment. Moreover, the one or more computing platforms 1202 may host/store encrypted content that is received or uploaded as a content post for the social networking system, for example.

The computing platform(s) 1202 may be configured to communicate with one or more remote platforms 1204 according to a client/server architecture, a peer-to-peer architecture, and/or other architectures. The remote platform(s) 1204 may be configured to communicate with other remote platforms via computing platform(s) 1202 and/or according to a client/server architecture, a peer-to-peer architecture, and/or other architectures.

The computing platform(s) 1202 may be configured by machine-readable instructions 1206. The machine-readable instructions 1206 may be executed by the computing platform(s) to implement one or more instruction modules. The instruction modules may include computer program modules.

In some implementations, the computing platform(s) 1202, the remote platform(s) 1204, and/or the external resources 1224 may be operatively linked via one or more electronic communication links. For example, such electronic communication links may be established, at least in part, via the network 1230 such as the Internet and/or other networks. The network 1230 can be a local area network (LAN), a wide area network (WAN), a mesh network, a hybrid network, or other wired or wireless networks. The network 1230 may be the Internet or some other public or private network. Client computing devices can be connected to network 1230 through a network interface, such as by wired or wireless communication. The connections can be any kind of local, wide area, wired, or wireless network, including the network 1230 or a separate public or private network. It will be appreciated that this is not intended to be limiting, and that the scope of this disclosure includes implementations in which the computing platform(s) 1202, the remote platform(s) 1204, and/or the external resources 1224 may be operatively linked via some other communication media.

A given remote platform 1204 may include client computing devices, such as virtual/augmented reality devices, mobile devices, tablets, personal computers, laptops, and desktops, which may each include one or more processors configured to execute computer program modules. The computer program modules may be configured to enable an expert or user associated with the given remote platform 1204 to interface with the system 1200 and/or external resources 1224, and/or provide other functionality attributed herein to remote platform(s) 1204. By way of non-limiting example, a given remote platform 1204 and/or a given computing platform 1202 may include one or more of a servers, a desktop computer, a laptop computer, a handheld computer, a tablet computing platform, a NetBook, a Smartphone, a gaming console, and/or other computing platforms. The external resources 1224 may include sources of information outside of the system 1200, external entities participating with the system 1200, and/or other resources.

The computing platform(s) 1202 may include the electronic storage 1226, a processor such as the processors, and/or other components. The computing platform(s) 1202 may include communication lines, or ports to enable the exchange of information with a network and/or other computing platforms. Illustration of the computing platform(s) 1202 in FIG. 12 is not intended to be limiting. The computing platform(s) 1202 may include a plurality of hardware, software, and/or firmware components operating together to provide the functionality attributed herein to the computing platform(s) 1202. For example, the computing platform(s) 1202 may be implemented by a cloud of computing platforms operating together as the computing platform(s) 1202.

The electronic storage 1226 may comprise non-transitory storage media that electronically stores information. The electronic storage media of the electronic storage 1226 may include one or both of system storage that is provided integrally (i.e., substantially non-removable) with computing platform(s) 1202 and/or removable storage that is removably connectable to computing platform(s) 1202 via, for example, a port (e.g., a USB port, a firewire port, etc.) or a drive (e.g., a disk drive, etc.). The electronic storage 1226 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 1226 may include one or more virtual storage resources (e.g., cloud storage, a virtual private network, and/or other virtual storage resources). The electronic storage 1226 may store software algorithms, information determined by the processor(s) 1201, information received from computing platform(s) 1202, information received from the remote platform(s) 1204, and/or other information that enables the computing platform(s) 1202 to function as described herein.

The processor(s) 1201 may be configured to provide information processing capabilities in the computing platform(s) 1202. As such, the processor(s) 1201 may include one or more of a digital processor, an analog processor, a digital circuit designed to process information, an analog circuit designed to process information, a state machine, and/or other mechanisms for electronically processing information. In some implementations, the processor(s) 1201 may include a plurality of processing units. These processing units may be physically located within the same device, or the processor(s) 1201 may represent processing functionality of a plurality of devices operating in coordination. The processor(s) 1201 may be configured to execute modules 1208, 1210, 1212, 1214, 1216, 1218, 1220 and/or other modules. The processor(s) 1201 may be configured to execute modules 1208, 1210, 1212, 1214, 1216, 1218, 1220 and/or other modules by software; hardware; firmware; some combination of software, hardware, and/or firmware; and/or other mechanisms for configuring processing capabilities on the processor(s) 1201. As used herein, the term “module” may refer to any component or set of components that perform the functionality attributed to the module. This may include one or more physical processors during execution of processor readable instructions, the processor readable instructions, circuitry, hardware, storage media, or any other components.

The Front-end Web module 1208 comprises the user interface where the participant can provide information for the system to evaluate. The graphical user interface in the Front-end Web module 408 can also display prompt requests as well as graphical information that can facilitate the participant(s) providing additional information to the front-end.

The Historical Open-end Data module 1210 can be a stored set of open-ended input responses. The Historical Open-end Data module 1210 can function as an artificial intelligence model that can categorize the open-ended data into a plurality of categories. Thus when an input is received via the Front-end Web module 1208, the Historical Open-end Data module 1210 can identify categories of prompts that can be associated with the input data. The Research Domain Knowledge module 1220 is another AI module that can be used identify a set of probes with an increased probability of being associated with the input data. The set of probes can then be the basis of determining which prompts can be fed back to the survey participant in the front-end.

The Computing Platform 1202 can also comprise multiple models that work in tandem with the AI modules. The Classifier module 1214 can further categorize the input received from the Historic Open-end Data module 1210. The Classifier module 1214 can further quantify the strength of the association made by the Historical Open-end Data module 1210 by performing validation calculations involving a threshold value and a likeliness score associated with the identified categories. The QA Model 1216 can receive the input and the set of probes from the Research Domain Knowledge module 1212 and determine whether the probe satisfies the open-ended input data. The Development Web Service module 1218 can be a program interface that serves as a protocol conversion conduit between the platform of the Front-end Web module 1208 and the other modules such as the Classifier module 414, QA Model 1216, Historic Open-end Data module 1210, and Research Domain Knowledge module 1212. In another aspect, the Development web module 1218 can provide an entry/exit point for any component requesting data from the Classifier model 414. The Development Web Service module 1218 can define the rules of any request to the Classifier module 414, in terms of the data structure that needs to be provided and validates those rules. The Development Web Service identifies the location of the currently available classifier in a facility where scalability means there may be multiple classifier models running simultaneously. The Development Web Service Module can also format the output of the classifier and returns the output with the relevant tokens to the service to ensure that any request made is serviced with a response. The Business Research Logic module 1220 can be a program that functions as middleware between the Front-end Web module 1208 and Back-end AI modules, Historic Open-end Data module 1210, and Research Domain Knowledge module 1212. The Business Research Logic module 1220 can validate the matching categories between a verbatim and associated category; the category respective score, threshold, and probes associated with each category indicating whether a probe has been satisfied.

It should be appreciated that although the modules 1208, 1210, 1212, 1214, 1216, 1218 and/or 1220 are illustrated in FIG. 4 as being implemented within a single processing unit, in implementations in which the processor(s) 401 includes multiple processing units, one or more of the modules 1208, 1210, 1212, 1214, 1216, 1218, and/or 1220 may be implemented remotely from the other modules. The description of the functionality provided by the different modules 1208, 1210, 1212, 1214, 1216, 1218 and/or 1220 described herein is for illustrative purposes, and is not intended to be limiting, as any of the modules 1208, 1210, 1212, 1214, 1216, 1218, and/or 1220 may provide more or less functionality than is described. For example, one or more of the modules 1208, 1210, 1212, 1214, 1216, 1218 and/or 1220 may be eliminated, and some or all of its functionality may be provided by other ones of the modules 1208, 1210, 1212, 1214, 1216, 1218, and/or 1220. As another example, the processor(s) 110 may be configured to execute one or more additional modules that may perform some or all of the functionality attributed below to one of the modules 1208, 1210, 1212, 1214, 1216, 1218 and/or 1220.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

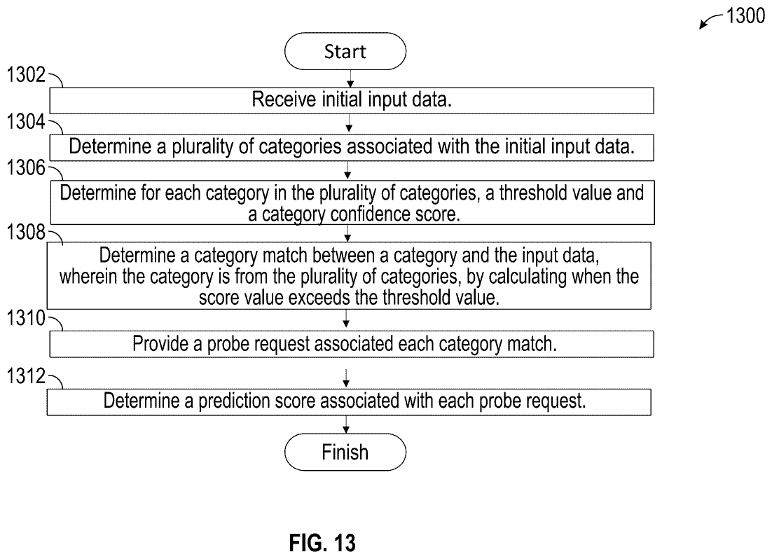

FIG. 13 illustrates an example flow diagram (e.g., process 1300) for providing an open-ended response to a prompt and soliciting additional information. For explanatory purposes, the example process 1300 is described herein with reference to one or more of the figures above. Further for explanatory purposes, the steps of the example process 1300 are described herein as occurring in serial, or linearly. However, multiple instances of the example process 1300 may occur in parallel. For purposes of explanation of the subject technology, the process 1300 will be discussed in reference to one or more of the figures above.

At step 1302, the system can receive initial input data at the Front-end Web Component of the system. In a further aspect, the rate at which the data is provided can initiate communication between the front-end and middleware to adjust and/or update probes for additional information from the respondent. At step 1304, the classifier model can determine a plurality of categories associated with the initial input data. At step 1306, with each category that has been identified, a threshold value and a category likeliness score can be determined. In a further aspect, the relevance of a category can be defined by comparing the threshold value for the category and the category likeliness score value. At step 1308, the system can determine a category match between a category and the input data received from the respondent. In one aspect, the system can determine if there is a match between the input data and the category when the likeliness score value exceeds the threshold value. At step 1310, the system can generate probe requests associated with each category match. The probe can be used by the system to prompt the respondent to provide additional information associated with the underlying category. At step 1312, the system can determine a prediction score associated with each probe request. In a further aspect, the system can receive additional information based on the prompt from a probe request. The system can also analyze the initial open-ended input and the additional input from the probe request to generate additional probe request(s) to prompt a survey participant to adjust their input. The system can be configured to respond to positive or negative inputs.

In one embodiment, the system can be aimed to deliver against a specification that defined how to respond to Dislike questions. An example probe could be: What did you dislike about the 10:00 pm news broadcast last night? In such an implementation, the system can focus on identifying one topic within the respondent's verbatim that the system deems to be relevant and to probe for more information, if required to ensure that that topic was richly described.

The Dislikes specification can be customized further to adapt to and be responsive to certain industry needs. For example, to address the needs of certain companies, the fact that the measure for relevance can be defined by multiple category lists. To address automotive industry needs, such category lists could be, for example, a what, of What is wrong with a vehicle? and a where, Where in the vehicle is the problem? The combination of multiple category lists can then be used to determine and fine-tune relevance.

In one embodiment, Dislikes handles just one what/where combination at a time, single statement. If there is more than one statement included in the verbatim, the dominant one was evaluated.

Richness can then be defined by a set of probes for each relevant combination of what/where. The verbatim was evaluated against these probes to determine whether the verbatim provided content to answer them. If the verbatim did not answer the probe, then the most important, unanswered probe was displayed for the user.

Like all implementations of the AutoProbe platform, the question is optional. The respondent is presented with an augmented multi-line edit control and asked to provide an answer. They can, at any time, move to the next question. No one is forced to respond.

In another embodiment, the system can be aimed to respond to Like questions. While the principle of Likes is similar to Dislikes, there are differences. For example, Likes can evaluate a multi-statement response, have only one category running in the categorization model, does not require the categories to be as specific as Dislikes, include an “other” category for low incidence likes, and support multiple visible probes within the respondent user interface.

The system can be utilized in various industries by providing new streams of coded verbatims. Each stream is coded into categories. The number of categories allowed is variable. To provide multi-language support, verbatims are provided in a range of languages with categories consistently applied across languages. If the quality of evaluation deteriorates for a specific language, an option is provided to provide additional training data in that language.

The system can generate detailed logs of every transaction that takes place. This includes the inputs and outputs of each call to the Classifier and QA models. In the case of the classifier, in situations where the likeliness score is significantly close to the threshold score, the log is analyzed to ensure that the choice to match, or not, the category to the verbatim, is manually evaluated. In situations where allocation was incorrect, the researcher can mark the data and provide the correct allocation. This information is collected and used to perform batch improvements of the Classifier by adding the data as training data and re-training the model.

Exemplary combinations of the above features can be provided in system implementations. For example, an iteration of the system can provide support for the Dislikes question. Such a system could support only a single language and single statements (finding one matching category in the verbatim rather than multiple). The system could be set to process a verbatim when there was a 2-second pause in typing. If waiting for a 2-second pause was deemed too slow, the pause value could be revised or calibrated. For example, if respondents were typing a single phrase and immediately pressing Next causing the system to not have enough time to display a prompt.

In another iteration of the system, the system could be programmed to count characters with evaluations of the full verbatim every 20 characters. The ability to configure the regularity of evaluation would then be added to the interface, e.g., ADC implementation, to allow variations based on language.

In yet another iteration of the system, the system could focus on Likes support. Alternatively, an iteration of the system could provide researchers or respondents the survey with the option to indicate whether the questions should be Likes or Dislikes based on if there is a preference from the respondence. Multi-statements could also be supported, and the UI adjusted to allow multiple probes to be displayed for a single verbatim. Additionally, the system can implement an evaluation of the change in content following any action. The current verbatim would then be compared to the previously submitted verbatim to see if it has significantly changed.

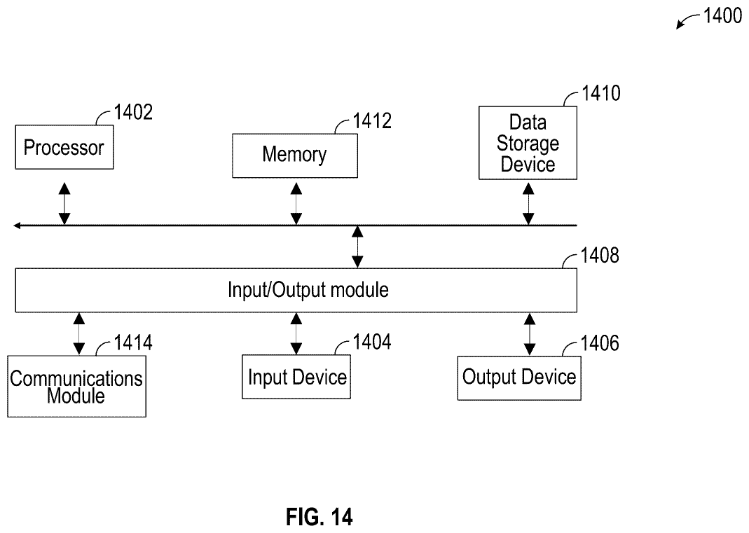

FIG. 14 is a block diagram illustrating an exemplary computer system 1400 with which aspects of the subject technology can be implemented. In certain aspects, the computer system 1400 may be implemented using hardware or a combination of software and hardware, either in a dedicated server, integrated into another entity, or distributed across multiple entities.

The computing system 1400 can include one or more processor(s) 1402, e.g., central processing units (CPUs), graphical processing units (GPUs), holographic processing units (HPUs), etc. The processors 1402 can be a single processing unit or multiple processing units in a device or distributed across multiple devices (e.g., distributed across two or more computing devices). The computing system 1400 can include one or more input devices 1404 that provide input to the processors 1402, notifying them of actions. The actions can be mediated by a hardware controller that interprets the signals received from the input device 1404 and communicates the information to the processors 1402 using a communication protocol. The processors 1402 can be coupled to other hardware devices, for example, with the use of an internal or external bus, such as a PCI bus, SCSI bus, wireless connection, and/or the like. The processors 1402 can communicate with a hardware controller for devices, such as for a display 1406. The display 1406 can be used to display text and graphics. In some implementations, the display 1406 includes the input device 1404 as part of the display, such as when the input device 1404 is a touchscreen or is equipped with an eye direction monitoring system. In some implementations, the display is separate from the input device 1404. Other output devices 1406 can also be coupled to the processor, such as a network chip or card, video chip or card, audio chip or card, universal serial bus (USB), firewire or other external device, camera, printer, speakers, CD-ROM drive, DVD drive, disk drive, etc.

The computer system 1400 (e.g., server and/or client) includes an input/output module 1408 or other communication mechanism for communicating information, and a processor 1402 coupled with the bus 1408 for processing information. By way of example, the computer system 1400 may be implemented with one or more processors 1402. Each of the one or more processors 1402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable processor, components, integration, or device entity that can perform calculations or other manipulations of information.

The computing system 1400 can include a communication device capable of communicating through wires or wirelessly with other local computing devices or a network node. The communication device can communicate with another device or a server through a network using, for example, protocols, such as TCP/IP (Transmission Control Protocol/Internet Protocol). The computing system 1400 can utilize the communication device to distribute operations across multiple network devices. The processors 1402 can have access to a memory 1412, which can be contained on one of the computing devices of computing system 1400 or can be distributed across one of the multiple computing devices of computing system 1400 or other external devices. A memory includes one or more hardware devices for volatile or non-volatile storage, and can include both read-only and writable memory. For example, a memory can include one or more of random-access memory (RAM), various caches, central processing unit (CPU) registers, read-only memory (ROM), and writable non-volatile memory, such as flash memory, hard drives, floppy disks, compact discs (CDs), digital video discs (DVDs), magnetic storage devices, tape drives, and so forth. A memory is not a propagating signal divorced from underlying hardware; a memory is thus non-transitory. The memory 1412 can include program memory that stores programs and software. The memory 1412 can also include data memory that can include information to be provided to the program memory or any element of the computing system.

The computer system 1400 can include, in addition to hardware, code that creates an execution environment for the computer program in question, e.g., code that constitutes processor firmware, a protocol stack, a database management system, an operating system, or a combination of one or more of them stored in included memory 1412, such as RAM, flash memory, ROM, programmable Read-Only Memory (PROM), Erasable PROM (EPROM), registers, a hard disk, a removable disk, a CD-ROM, a DVD, or any other suitable storage device, coupled to bus 1408 for storing information and instructions to be executed by processor 1402. The processor 1402 and the memory 1404 can be supplemented by, or incorporated in, special purpose logic circuitry.

The instructions may be stored in the memory 1412 and implemented in one or more computer program products, i.e., one or more modules of computer program instructions encoded on a computer-readable medium for execution by, or to control the operation of, the computer system 1400, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 1412 may also be used for storing temporary variable or other intermediate information during execution of instructions to be executed by the processor 1402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 1400 further includes a data storage device 1410 such as a magnetic disk or optical disk, coupled to bus 1408 for storing information and instructions. The computer system 1400 may be coupled via input/output module 1408 to various devices. Exemplary input/output modules 1408 include data ports such as USB ports. The input/output module 1412 is configured to connect to a communications module 1414. Exemplary communications modules 1414 include networking interface cards, such as Ethernet cards and modems. In certain aspects, the input/output module 1408 is configured to connect to a plurality of devices, such as an input device 1414 and/or an output device 1406. Exemplary input devices 1404 include a physical or digital keyboard and a pointing device, e.g., a mouse, trackpad, or a trackball, by which a user can provide input to the computer system 1400. Other kinds of input devices can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1406 include display devices such as an LCD (liquid crystal display), LED (light emitting diode), projection, plasma, cathode ray tube (CRT), or other monitor(s), for displaying information to the user.

According to one aspect of the present disclosure, the above-described systems can be implemented using a computer system 1400 in response to the processor 1402 executing one or more sequences of one or more instructions contained in the memory 1412. Such instructions may be read into memory 1412 from another machine-readable medium, such as data storage device 1410. Execution of the sequences of instructions contained in the main memory 1412 causes the processor 1402 to perform the process steps described herein. One or more processors in a multi-processing arrangement may also be employed to execute the sequences of instructions contained in the memory 1412. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., such as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

The computer system 1400 can include clients and servers. A client and server are generally remote from each other and typically interact through a communication network. The relationship of client and server arises by virtue of computer programs running on the respective computers and having a client-server relationship to each other. The computer system 1400 can be, for example, and without limitation, a desktop computer, laptop computer, or tablet computer. The computer system 1400 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions to the processor 1402 for execution. Such a medium may take many forms, including, but not limited to, non-volatile media, volatile media, and transmission media. Non-volatile media include, for example, optical or magnetic disks, such as the data storage device 1410. Volatile media include dynamic memory, such as the memory 1412. Transmission media include coaxial cables, copper wire, and fiber optics, including the wires that comprise the bus 1408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip, or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for providing automated feedback to open-ended input data, the method comprising:
receiving initial input data;
determining a plurality of categories associated with the initial input data;
determining for each category in the plurality of categories, a threshold value and a category likeliness score value;
determining a category match between a category and the input data, wherein the category is from the plurality of categories, by calculating when the likeliness score value exceeds the threshold value;
providing a probe request associated each category match; and
determining a prediction score associated with each probe request.

2. The computer-implemented method of claim 1, further comprising receiving supplemental input data.

3. The computer-implemented method of claim 2, further comprising determining a change in the initial input data and supplemental input data, wherein determining the change comprises identifying at least one of: a change in data input rate, input stoppage, or character change.

4. The computer-implemented method of claim 3, further comprising generating at least one secondary prompt request, wherein the secondary prompt request is associated with the combination of the initial input data and supplemental input data.

5. The computer-implemented method of claim 1, wherein determining the prediction score associated with each probe request further comprises providing a portion of the initial input data or supplemental input data that matches the probe request.

6. The computer-implemented method of claim 1, further comprising validating the threshold value for each category.

7. The computer-implemented method of claim 6, wherein validating the threshold value comprises calculating a percentage ratio of a correctly associated category with input data to an incorrectly associated data with the input data.

8. A system is provided including a processor and a memory comprising instructions stored thereon, which when executed by the processor, causes the processor to perform a method for:
receiving initial input data;
determining a plurality of categories associated with the initial input data;
determining for each category in the plurality of categories, a threshold value and a category likeliness score value;
determining a category match between a category and the input data, wherein the category is from the plurality of categories, by calculating when the likeliness score value exceeds the threshold value;
providing a probe request associated each category match; and
determining a prediction score associated with each probe request.

9. The system of claim 8, further comprising receiving supplemental input data.

10. The system of claim 9, further comprising determining a change in the initial input data and supplemental input data, wherein determining the change comprises identifying at least one of: a change in data input rate, input stoppage, or character change.

11. The system of claim 10, further comprising generating at least one secondary prompt request, wherein the secondary prompt request is associated with the combination of the initial input data and supplemental input data.

12. The system of claim 8, wherein determining the prediction score associated with each probe request further comprises providing a portion of the initial input data or supplemental input data that matches the probe request.

13. The system of claim 8, further comprising validating the threshold value for each category.

14. The system of claim 13, wherein validating the threshold value comprises calculating a percentage of a correctly associated category with input data to an incorrectly associated data with the input data.

15. A non-transitory computer-readable storage medium comprising instructions stored thereon, which when executed by one or more processors, cause the one or more processors to perform operations for providing an encryption key exchange, comprising:
receiving initial input data;
determining a plurality of categories associated with the initial input data;
determining for each category in the plurality of categories, a threshold value and a category likeliness score value;
determining a category match between a category and the input data, wherein the category is from the plurality of categories, by calculating when the likeliness score value exceeds the threshold value;
providing a probe request associated each category match; and
determining a prediction score associated with each probe request.

16. The non-transitory computer-readable storage medium of claim 8, further comprising receiving supplemental input data.

17. The non-transitory computer-readable storage medium of claim 9, further comprising determining a change in the initial input data and supplemental input data, wherein determining the change comprises identifying at least one of: a change in data input rate, input stoppage, or character change.

18. The non-transitory computer-readable storage medium of claim 10, further comprising generating at least one secondary prompt request, wherein the secondary prompt request is associated with the combination of the initial input data and supplemental input data.

19. The non-transitory computer-readable storage medium of claim 8, determining the prediction score associated with each probe request further comprises providing a portion of the initial input data or supplemental input data that matches the probe request.

20. The non-transitory computer-readable storage medium of claim 8, further comprising validating the threshold value for each category, wherein validating the threshold value comprises calculating a percentage of a correctly associated category with input data to an incorrectly associated data with the input data.
